(19) United States
(12) Patent Application Publication
(10) Pub. No.: US 2024/0296325 A1
(43) Pub. Date: Sep. 5, 2024

(54) NEURAL NETWORK DEVICE AND SYNAPTIC WEIGHT UPDATE METHOD

(71) Applicant: KABUSHIKI KAISHA TOSHIBA, Tokyo (JP)

(72) Inventors: Yoshifumi NISHI, Yokohama Kanagawa (JP); Kumiko NOMURA, Shinagawa Tokyo (JP); Takao MARUKAME, Chuo Tokyo (JP); Koichi MIZUSHIMA, Kamakura Kanagawa (JP)

(73) Assignee: KABUSHIKI KAISHA TOSHIBA, Tokyo (JP)

(21) Appl. No.: 18/521,665

(22) Filed: Nov. 28, 2023

(30) Foreign Application Priority Data
Mar. 1, 2023 (JP) 2023-031023

(51) Int. Cl. G06N 3/08; G06N 3/047; G06N 3/049; G06N 3/063

(52) U.S. Cl. CPC G06N 3/08; G06N 3/047; G06N 3/049; G06N 3/063

(57) ABSTRACT

A neural network device according to an embodiment includes a plurality of neuron circuits, a plurality of synapse circuits, and a plurality of random number circuits. Each of the random number circuits outputs a random signal. Each of the synapse circuits receives the random signal from one of the random number circuits and updates a synaptic weight with a probability generated on the basis of the received random signal. The synapse circuits are divided into synapse groups. Each of two or more synapse circuits belonging to a first synapse group receives the random signal output from a first random number circuit. Each of two or more synapse circuits outputting output signals to a first neuron circuit belongs to a synapse group differing from a synapse group, to which other synapse circuits outputting the output signal to the first neuron circuit, belong.

### CROSS-REFERENCE TO RELATED APPLICATIONS

This application is based upon and claims the benefit of priority from Japanese Patent Application No. 2023-031023, filed on Mar. 1, 2023; the entire contents of which are incorporated herein by reference.

### FIELD

Embodiments described herein relate generally to neural network devices and synaptic weight update methods.

### BACKGROUND

In recent years, with advances in computer hardware, typified by graphical processing units (GPU), artificial intelligence technology has been rapidly developing. For example, image recognition and classification techniques, typified by convolutional neural networks (CNN), have already been used in various scenes in the real world. Artificial intelligence technology that is widely used now is based on the mathematical model in which the behavior of biological neural networks is simplified. Such artificial intelligence technology is therefore implemented using computers, such as GPUs.

However, the implementation of the artificial intelligence technology with GPUs requires a large amount of power. In particular, learning operation in which features are extracted from a large volume of data and stored comes with an enormous amount of computation. Such learning operation therefore requires a significant amount of power and is considered difficult to execute in edge devices, for example.

On the other hand, although its energy consumption is as low as 20 W, the human brain constantly learns an enormous volume of data online. Therefore, a technique of performing information processing by relatively faithfully reproducing brain activity by electric circuits has been studied in various countries of the world.

In the brain's neural network, information is transmitted from a neuron (nerve cell) to a neuron as a signal of a voltage spike. A coupler called a synapse couples a neuron to a neuron. When a neuron fires and generates a voltage spike, the voltage spike is input to a post-neuron via a synapse. At this time, the strength of the voltage spike input to the post-neuron is adjusted by the coupling strength of the synapse (also called a synaptic weight). When the synaptic weight is large, the voltage spike is transmitted to the post-neuron with the strength remaining high.

However, when the synaptic weight is small, the voltage spike is transmitted to the post-neuron with the strength decreased. Therefore, in the brain's neural network, the larger the synaptic weight coupling two neurons, the closer the informational relationship between these two neurons.

It is known that the synaptic weight changes depending on the input timing of the voltage spike and the internal state of the neuron. The best known synapse update rule is spike timing dependent plasticity (STDP).

The synapse update rule according to STDP provides the follow operation. That is, assume that a voltage spike is input from a neuron (pre-neuron) via a synapse to a subsequent neuron (post-neuron). In response to the input of the voltage spike from the pre-neuron, the inner potential of the post-neuron reaches a threshold. When this results in firing of the post-neuron, there is a causal relationship between information held by the pre-neuron and information held by the post-neuron. In this case, the synaptic weight of the synapse coupling the pre-neuron to the post-neuron is large. In contrast, when a voltage spike is input from a pre-neuron to a post-neuron after the post-neuron fires, there is no causal relationship between information held by the pre-neuron and information held by the post-neuron. In this case, the synaptic weight of the synapse coupling the pre-neuron to the post-neuron is small.

Such information processing mimicking the information transmission principle of the brain's neural network is called spiking neural networks. The spiking neural network represents the flow of information in the brain's neural network as spike trains. The spiking neural network performs no numerical computation and performs information processing by accumulating, generating, and transmitting voltage spikes. Conventional artificial intelligence requires an enormous amount of computation in learning operation. However, the spiking neural network learns synaptic weights using an update rule, such as STDP, and can therefore perform efficient learning operation.

Synaptic weights are typically represented by continuous values. The synaptic weight changes by the amount determined by the synapse update rule. Therefore, a spiking neural network configured by hardware should include memory to store synaptic weights represented by continuous values. Memory that is widely used now stores information in digital form. Memory taking digital form should have a large number of bits sufficient to handle values to be stored as continuous values. Therefore, the spiking neural network configured by hardware has such a problem in that the memory capacity is increased to store synaptic weights represented by continuous values in memory taking digital form.

Analog memory, such as resistive random access memory and phase-change memory, is also known that stores analog values. However, analog memory requires precise signal control to accurately store target values. Therefore, a spiking neural network, which is configured by hardware and provided with analog memory, has such a problem in that the circuit and system for controlling the analog memory increase in complexity and size.

To avoid these problems, it is considered that a spiking neural network configured by hardware uses synaptic weights represented by discrete values. For example, it is considered that a spiking neural network configured by hardware uses binarized synaptic weights, that is, synaptic weights represented by 0 or 1. However, in the spiking neural network using binarized synaptic weights, the amount of change in the synaptic weight is 1, so that it is difficult to appropriately represent the change in the synaptic weight depending on the input timing of the voltage spike and the internal state of the neuron. Therefore, a spiking neural network configured by hardware, when using synaptic weights represented by discrete values, for example, in binary, is difficult to appropriately perform learning with small-scale circuitry.

### BRIEF DESCRIPTION OF THE DRAWINGS

FIG. 1 is a block diagram of a neural network device according to a first embodiment;

FIG. 2 is a block diagram of a reservoir computing apparatus;

FIG. 3 is a diagram illustrating a connection relationship based on STDP in the first embodiment;

FIG. 4 is a diagram illustrating example update probability based on STDP;

FIG. 5 is a diagram illustrating another example update probability based on STDP;

FIG. 6 is a diagram illustrating a connection relationship based on Fusi rule in the first embodiment;

FIG. 7 is a diagram illustrating example update probability based on Fusi rule;

FIG. 8 is a block diagram of a synapse circuit according to the first embodiment;

FIG. 9 is a block diagram of the synapse circuit based on STDP according to the first embodiment;

FIG. 10 is a block diagram of the synapse circuit based on Fusi rule according to the first embodiment;

FIG. 11 is a diagram illustrating a spiking neural network;

FIG. 12 is a diagram illustrating recognition rates when independent random signals are received;

FIG. 13 is a diagram illustrating recognition rates when common random signals are received;

FIG. 14 is a diagram illustrating a first connection example of the first embodiment;

FIG. 15 is a diagram illustrating a second connection example of the first embodiment;

FIG. 16 is a diagram illustrating a third connection example of the first embodiment;

FIG. 17 is a diagram illustrating a fourth connection example of the first embodiment;

FIG. 18 is a diagram illustrating recognition rates in the first embodiment;

FIG. 19 is a diagram illustrating the numbers of transistors relative to the numbers of neurons;

FIG. 20 is a block diagram of a neural network device according to a second embodiment;

FIG. 21 is a diagram illustrating a connection relationship based on STDP in the second embodiment;

FIG. 22 is a block diagram of a synapse circuit according to the second embodiment;

FIG. 23 is a block diagram of a probability control circuit according to the second embodiment;

FIG. 24 is a diagram illustrating a first connection example of the second embodiment;

FIG. 25 is a diagram illustrating a second connection example of the second embodiment;

FIG. 26 is a diagram illustrating a third connection example of the second embodiment;

FIG. 27 is a diagram illustrating recognition rates in the second embodiment; and

FIG. 28 is a diagram illustrating recognition rates when a first probability and a second probability are varied.

### DETAILED DESCRIPTION

A neural network device according to one embodiment includes a plurality of neuron circuits, a plurality of synapse circuits, and a plurality of random number circuits. Each of the neuron circuits is configured to receive an output signal output from each of one or more of the synapse circuits and output a firing signal in accordance with the received output signal. Each of the random number circuits is configured to output a random signal representing a random number periodically changed. Each of the synapse circuits includes a storage circuit, a transmission circuit, a probability control circuit, and an update circuit. The storage circuit is configured to store a synaptic weight. The transmission circuit is configured to receive an input signal being the firing signal output from a pre-neuron circuit being one of the neuron circuits, and output an output signal to a post-neuron circuit being one of the neuron circuits. The output signal is obtained by adding influence of the synaptic weight to the received input signal. The probability control circuit is configured to receive the random signal from one of the random number circuits. The probability control circuit is configured to permit update of the synaptic weight with a probability generated based on the received random signal, and prohibit update of the synaptic weight unless the synaptic weight is permitted to be updated. The update circuit is configured, when the input signal is received from the pre-neuron circuit, to update the synaptic weight in accordance with a feedback signal on condition that the synaptic weight is permitted to be updated. The feedback signal represents operation of the post-neuron circuit or a state of the post-neuron circuit. The synapse circuits are divided into synapse groups. Two or more synapse circuits are each configured to receive the random signal output from a first random number circuit out of the random number circuits. The two or more synapse circuits belong to a first synapse group out of the synapse groups. Two or more synapse circuits, each outputting the output signal to a first neuron circuit out of the neuron circuits, belong to a synapse group differing from a synapse group to which other synapse circuits, each outputting the output signal to the first neuron circuit, belong.

Neural network devices 10 according to embodiments will be described below with reference to the drawings.

The neural network devices 10 of the embodiments are spiking neural networks configured by hardware and update synaptic weights according to stochastic update rules. The neural network devices 10 of the embodiments are able to learn accurately with small-scale circuitry. As a result, the neural network devices 10 of the embodiments can perform accurate inference with small-scale circuitry.

### First Embodiment

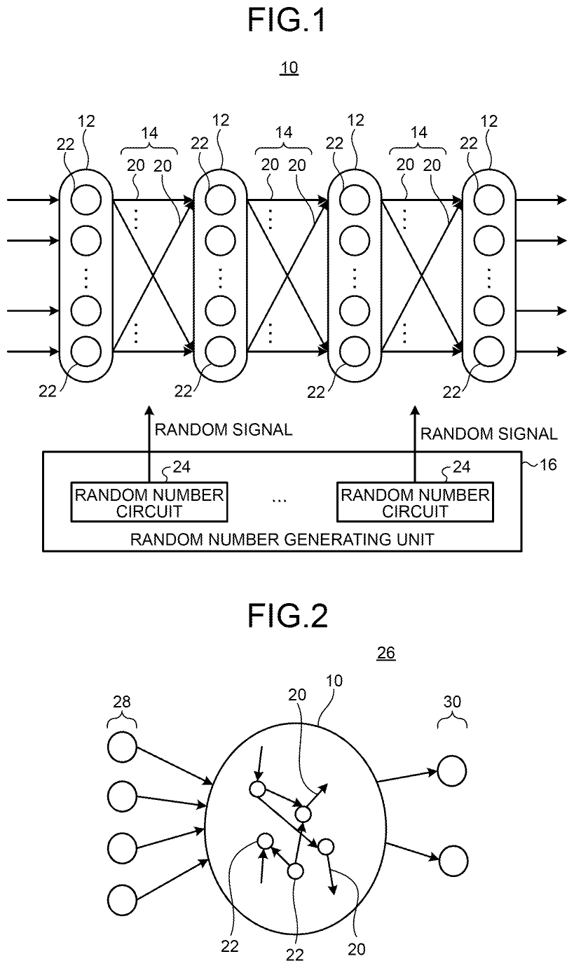

FIG. 1 is a diagram illustrating an example configuration of a neural network device 10 according to a first embodiment. The neural network device 10 of the first embodiment includes, for example, N-stage (N is an integer of 2 or larger) layers 12, (N-1) pieces of synapse units 14, and a random number generating unit 16.

Each of the N-stage layers 12 includes a plurality of neuron circuits 22. Each of the neuron circuits 22 acquires a plurality of signals output from the preceding-stage layer 12 via the preceding-stage synapse unit 14 and executes processing equivalent to a product-sum operation on the acquired signals. Note that the first-stage layer 12 in the N-stage layers 12 acquires a plurality of signals from an external device or an input layer. Each of the neuron circuits 22 then outputs a signal obtained by performing processing equivalent to an activating function on a signal representing the computation result. Note that each of the neuron circuits 22 may execute the processing equivalent to a product-sum operation with an analog circuit. Each of the neuron circuits 22 may execute the processing equivalent to an activating function with an analog circuit. Each of the neuron circuits 22 can execute the processing equivalent to a product-sum operation and the processing equivalent to an activating function with less power consumption by using an analog circuit.

Each of the (N-1) pieces of synapse units 14 includes a plurality of synapse circuits 20. Each of the synapse circuits 20 is assigned with a synaptic weight.

The nth (n is an integer of 1 through (N-1), both inclusive) synapse unit 14 in the (N-1) pieces of synapse units 14 is disposed between the nth-stage layer 12 and the (n+1)th-stage layer 12.

Each of the synapse circuits 20 included in the nth synapse unit 14 receives the signal output from one of the neuron circuits 22 included in the nth-stage layer 12 as a binary input signal. Each of the synapse circuits 20 included in the nth synapse unit 14 generates an output signal by adding the influence of the assigned synaptic weight to the received input signal. In present embodiment, the output signal is a binary voltage signal. Alternatively, the output signal may be a binary current signal. Each of the synapse circuits 20 included in the nth synapse unit 14 then gives the output signal to one of the neuron circuits 22 included in the (n+1)th-stage layer 12.

The random number generating unit 16 includes a plurality of random number circuits 24. Each of the random number circuits 24 outputs a random signal representing a random number periodically changed. Each of the random number circuits 24 is independent of the other random number circuits 24 in terms of circuits and generates a random signal representing a random number differing from those from the other random number circuits 24. Each of the random number circuits 24 is, for example, a pseudo random number generating circuit. The pseudo random number generating circuit is, for example, a linear feedback shift register (LFSR) circuit generated by a CMOS semiconductor circuit.

The random number represented by the random signal is a value in a predetermined range. For example, the random number represented by the random signal is a value in the range of 10-bit width (0 to 1023).

In this neural network device 10, the first-stage layer 12 receives one or more signals from the external device or the input layer. The neural network device 10 then outputs, from the Nth-stage layer 12, one or more signals indicating the result of the computations executed by the neural network on the received one or more signals.

Each of the synapse circuits 20 is assigned with a synaptic weight represented by a discrete value. In present embodiment, each of the synapse circuits 20 is assigned with a synaptic weight represented in binary.

Each of the synapse circuits 20 also receives the random signal output from one of the random number circuits 24. Each of the synapse circuits 20 then stochastically updates the assigned synaptic weight in accordance with a predetermined synapse update rule, with a probability signal generated on the basis of the received random signal. The probability signal is a signal having a first value (for example, 1) with a predetermined probability and having a second value (for example, 0) otherwise.

For example, each of the synapse circuits 20 updates the assigned synaptic weight in accordance with a stochastic update rule based on spike timing dependent synaptic plasticity (STDP). For example, each of the synapse circuits 20 updates the synaptic weight in accordance with the update rule based on STDP when the probability signal has the first value (for example, 1), and does not update the synaptic weight when the probability signal has the second value (for example, 0).

Alternatively, each of the synapse circuits 20 may update the assigned synaptic weight in accordance with, for example, a stochastic update rule based on Fusi rule described in Joseph M. Brader et al., “Learning real-world stimuli in a neural network with spike-driven synaptic dynamics”, Neural computation, Volume 19, Massachusetts Institute of Technology, P2881-2912 November 2007. In this case, for example, each of the synapse circuits 20 updates the synaptic weight in accordance with the update rule based on Fusi rule when the probability signal has the first value (for example, 1), and does not update the synaptic weight when the probability signal has the second value (for example, 0).

When the synaptic weight is represented in binary as 0 or 1, each of these synapse circuits 20 can change the synaptic weight from 0 to 1 or from 1 to 0 in accordance with the stochastic STDP update rule or the stochastic Fusi update rule. This enables the neural network device 10 to appropriately learn the synaptic weights even when the synaptic weights are represented by discrete values, for example, in binary.

FIG. 2 is a diagram illustrating a configuration of a reservoir computing apparatus 26 according to the embodiment.

The neural network device 10 is not limited to a configuration that transfers signals forward as illustrated in FIG. 1 and may be a recurrent neural network that internally feeds back signals. In a case where the neural network device 10 is a recurrent neural network, the neural network device 10 can be applied to the reservoir computing apparatus 26 as illustrated in FIG. 2, for example.

The reservoir computing apparatus 26 includes an input layer 28, the neural network device 10 being a recurrent neural network, and an output layer 30.

The input layer 28 acquires one or more signals from an external device. The input layer 28 gives the acquired one or more signals to the neural network device 10. The output layer 30 acquires one or more signals from the neural network device 10. The output layer 30 outputs the one or more signals to the external device.

Some of the neuron circuits 22 included in the neural network device 10 acquire the signals from the input layer 28. The synapse circuit 20 acquiring no signal from the input layer 28 receives a signal output from one of the neuron circuits 22 as an input signal. Some of the neuron circuits 22 give output signals to other neuron circuits 22. Some other neuron circuits 22 in the neuron circuits 22 give output signals to the output layer 30.

At least one of the synapse circuits 20 feeds back an output signal and gives the signal as an input signal to itself or another neuron circuit 22. In other words, at least one of the synapse circuits 20 gives an output signal to itself, the neuron circuit 22 that has given an input signal to itself, or the neuron circuit 22 in a stage previous to the neuron circuit 22 that has given an input signal to itself.

Note that, similar to FIG. 1, the neural network device 10 illustrated in FIG. 2 also includes the random number generating unit 16. Each of the synapse circuits 20 receives the random signal and updates the synaptic weight in accordance with a stochastic update rule.

The reservoir computing apparatus 26 having such a configuration can function as a hardware apparatus implementing reservoir computing.

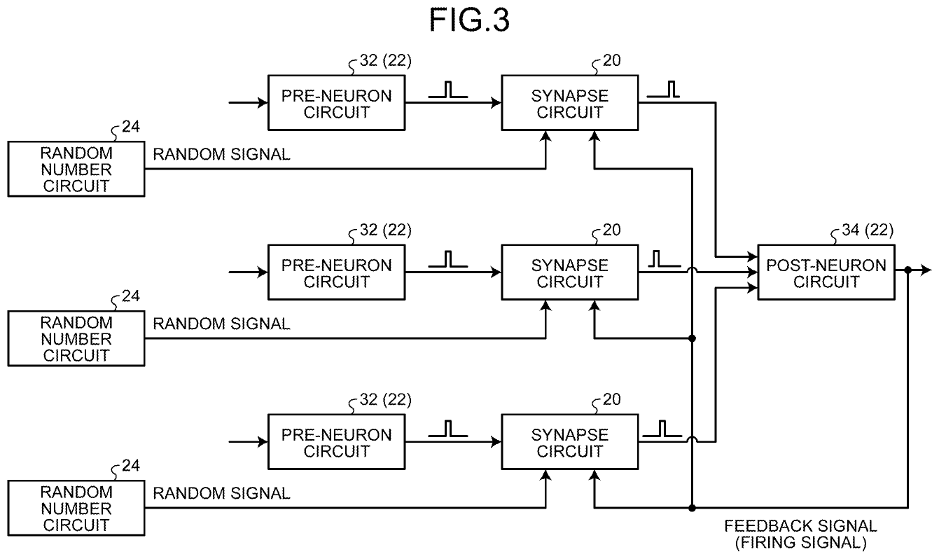

FIG. 3 is a diagram illustrating a connection relationship between the synapse circuits 20 and other circuits according to the first embodiment when the synaptic weights are updated in accordance with the stochastic update rule based on STDP.

Each of the synapse circuits 20 acquires a firing signal output from a pre-neuron circuit 32 being one of the neuron circuits 22, as an input signal. Each of the synapse circuits 20 outputs an output signal obtained by adding influence of the stored synaptic weight to the received input signal. The synapse circuit 20 then supplies the output signal to a post-neuron circuit 34 being one of the neuron circuits 22.

Each of the synapse circuits 20 receives a feedback signal from the post-neuron circuit 34. The feedback signal indicates the operation or the state of the post-neuron circuit 34.

In a case where the synaptic weight is updated in accordance with the stochastic update rule based on STDP, the feedback signal is a firing signal output from the post-neuron circuit 34. The firing signal is, for example, a binary signal representing the first value (for example, 1) or the second value (for example, 0), and changes from the second value (for example, 0) to the first value (for example, 1) at firing timing of the post-neuron circuit 34 and returns to the second value (for example, 0) after a given period of time. In other words, in a case where the synaptic weight is updated in accordance with the stochastic update rule based on STDP, the feedback signal is a signal having the first value (for example, 1) for a given period of time after firing of the post-neuron circuit 34 and having the second value (for example, 0) for the other period of time.

Each of the synapse circuits 20 also receives the random signal from one of the random number circuits 24.

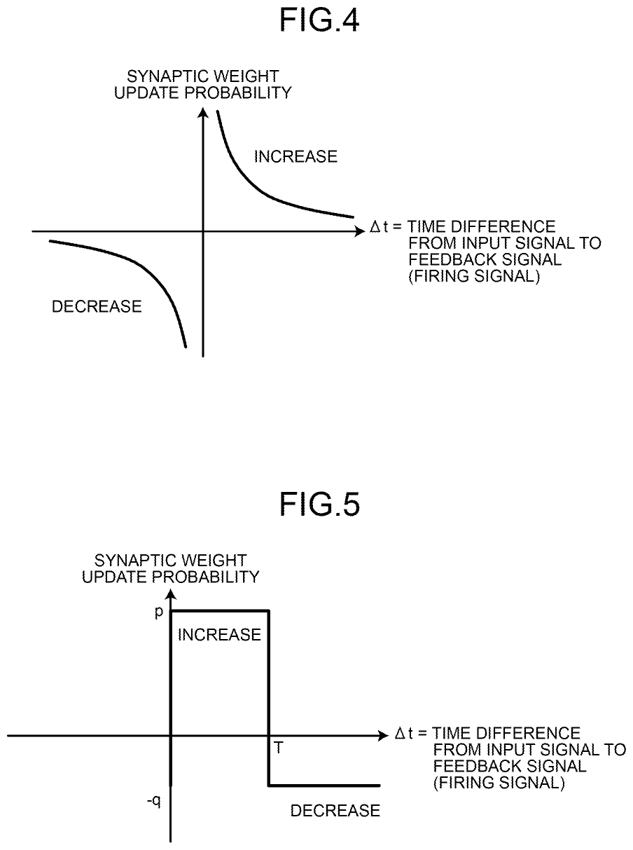

FIG. 4 is a diagram illustrating example update probability under the stochastic update rule based on STDP.

When the synaptic weight is updated in accordance with the stochastic update rule based on STDP, each of the synapse circuits 20 varies update probability in accordance with a time difference (Δt) from the input signal to the feedback signal. In other words, each of the synapse circuits 20 varies the update probability in accordance with a time difference (Δt) from timing at which the input signal is changed from the second value (for example, 0) to the first value (for example, 1) to timing at which the feedback signal is changed from the second value (for example, 0) to the first value (for example, 1).

For example, when the time difference (Δt) is positive, that is, when the input signal is generated and then the feedback signal is generated, each of the synapse circuits 20 changes the synaptic weight in an increment direction. In this case, each of the synapse circuits 20 increases the update probability as the absolute value of the time difference (Δt) is lower, and decreases the update probability as the absolute value of the time difference (Δt) is higher.

For example, when the time difference (Δt) is negative, that is, when the feedback signal is generated before the input signal is generated, each of the synapse circuits 20 changes the synaptic weight in a decrement direction. In this case, each of the synapse circuits 20 increases the update probability as the absolute value of the time difference (Δt) is lower, and decreases the update probability as the absolute value of the time difference (Δt) is higher.

This way of updating enables each of the synapse circuits 20 to update the synaptic weight in accordance with the closeness of the informational relationship between the pre-neuron circuit 32 and the post-neuron circuit 34. Additionally, each of the synapse circuits 20 can accurately learn the synaptic weight even when the synaptic weight has a discrete value, for example, in binary.

FIG. 5 is a diagram illustrating another example update probability under the stochastic update rule based on STDP. Instead of performing the update as illustrated in FIG. 4, each of the synapse circuits 20 may update the synaptic weight as illustrated in FIG. 5.

That is, when the time difference (Δt) is negative, each of the synapse circuits 20 does not update the synaptic weight. When the time difference (Δt) is positive and smaller than a predetermined value (T), each of the synapse circuits 20 stochastically increases the synaptic weight with a predetermined increase probability (p). When the time difference (Δt) is positive and equal to or larger than the predetermined value (T), each of the synapse circuits 20 stochastically decreases the synaptic weight with a predetermined decrease probability (q).

When the synaptic weight is updated in this way, each of the synapse circuits 20 can update the synaptic weight by measuring time from reception of the input signal until reception of the feedback signal with a timer. Therefore, each of the synapse circuits 20 can update the synaptic weight with a simple circuit.

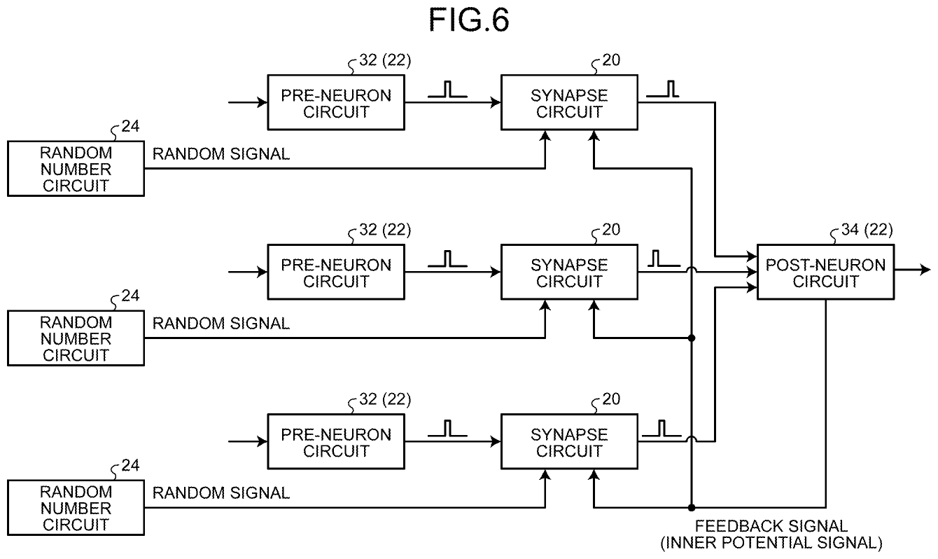

FIG. 6 is a diagram illustrating a connection relationship between the synapse circuits 20 and other circuits according to the first embodiment when the synaptic weights are updated in accordance with the stochastic update rule based on Fusi rule.

Each of the neuron circuits 22 holds an inner potential. Each of the neuron circuits 22 varies the inner potential in accordance with the level or duration of the output signal received from the synapse circuit 20 connected to the preceding stage. Then, when the inner potential becomes larger than a preset firing threshold, each of the neuron circuits 22 outputs a firing signal.

When the synaptic weight is updated in accordance with the stochastic update rule based on Fusi rule, the feedback signal is an inner potential signal representing the inner potential of the post-neuron circuit 34. The inner potential signal has, for example, the first value (for example, 1) when the inner potential is equal to or larger than a predetermined value and the second value (for example, 0) when the inner potential is smaller than the predetermined value.

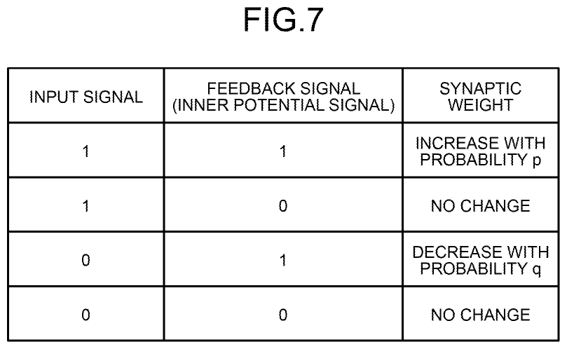

FIG. 7 is a diagram illustrating example update probability under the stochastic update rule based on Fusi rule.

When the synaptic weight is updated in accordance with the stochastic update rule based on Fusi rule, each of the synapse circuits 20 varies update probability in accordance with a combination of the value of the input signal and the value of the feedback signal.

For example, when the input signal has the first value (for example, 1) and when the inner potential signal has the first value (for example, 1), each of the synapse circuits 20 changes the synaptic weight in an increment direction with a predetermined increase probability (p). For example, when the input signal has the second value (for example, 0) and when the inner potential signal has the first value (for example, 1), each of the synapse circuits 20 changes the synaptic weight in a decrement direction with a predetermined decrease probability (q).

When the input signal has the first value (for example, 1) and when the inner potential signal has the second value (for example, 0), each of the synapse circuits 20 does not change the synaptic weight. When the input signal has the second value (for example, 0) and when the inner potential signal has the second value (for example, 0), each of the synapse circuits 20 does not change the synaptic weight.

This way of updating also enables each of the synapse circuits 20 to update the synaptic weight in accordance with the closeness of the informational relationship between the pre-neuron circuit 32 and the post-neuron circuit 34. Additionally, each of the synapse circuits 20 can accurately learn the synaptic weight even when the synaptic weight has a discrete value, for example, in binary.

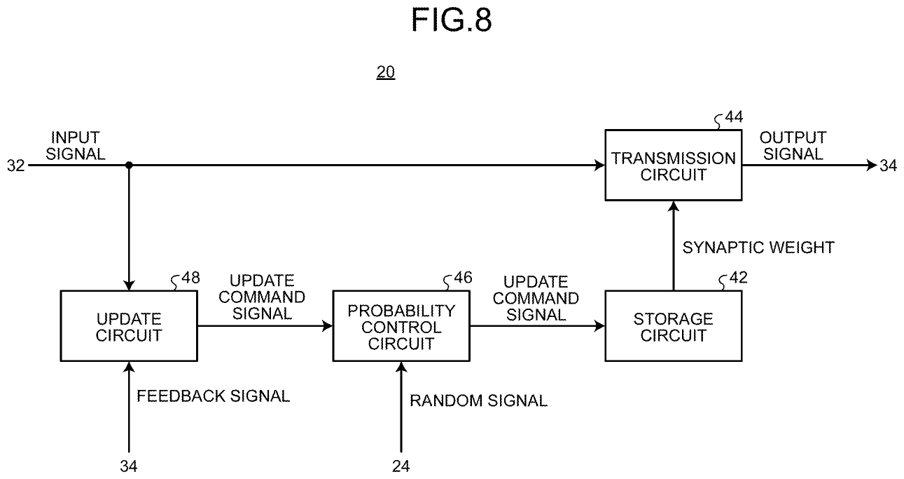

FIG. 8 is a diagram illustrating a configuration of the synapse circuit 20 according to the first embodiment. Each of the synapse circuits 20 includes a storage circuit 42, a transmission circuit 44, a probability control circuit 46, and an update circuit 48.

The storage circuit 42 stores the synaptic weight. In present embodiment, the storage circuit 42 stores a binary synaptic weight representing the first value (for example, 1) or the second value (for example, 0). Note that the storage circuit 42 may store a synaptic weight of a discrete value in ternary or larger form, a synaptic weight of a continuous value represented by a large number of bits, or a synaptic weight represented by an analog value.

The transmission circuit 44 receives the firing signal output from the pre-neuron circuit 32 as an input signal and supplies, to the post-neuron circuit 34, an output signal obtained by adding influence of the synaptic weight stored by the storage circuit 42 to the received input signal.

For example, when the input signal is received from the pre-neuron circuit 32 and when the synaptic weight stored by the storage circuit 42 has the first value (for example, 1), the transmission circuit 44 supplies an output signal of a first current amount to the post-neuron circuit 34. For example, when the input signal is received from the pre-neuron circuit 32 and when the synaptic weight stored by the storage circuit 42 has the second value (for example, 0), the transmission circuit 44 gives an output signal of a second current amount smaller than the first current amount to the post-neuron circuit 34.

Alternatively, for example, when the input signal is received from the pre-neuron circuit 32 and when the synaptic weight stored by the storage circuit 42 has the second value (for example, 0), the transmission circuit 44 may give no output signal to the post-neuron circuit 34. Alternatively, for example, when the input signal is received from the pre-neuron circuit 32 and when the synaptic weight stored by the storage circuit 42 has the second value (for example, 0), the transmission circuit 44 may give an output signal of a voltage level lower than when the synaptic weight has the first value (for example, 1) or an output signal delayed from when the synaptic weight has the first value (for example, 1). For example, the transmission circuit 44 may include the Differential Pair-Integrator (DPI) circuit described in Elisabetta Chicca, et al., “Neuromorphic Electronic Circuits for Building Autonomous Cognitive Systems”, Proceedings of the IEEE (Volume: 102, Issue: 9, September 2014), P1367-1388 May 1, 2014. In this case, the transmission circuit 44 outputs an output signal in accordance with a signal output from the DPI circuit. This transmission circuit 44 can supply, to the post-neuron circuit 34, an output signal obtained by adding influence of the synaptic weight stored by the storage circuit 42 to the received input signal.

The probability control circuit 46 receives the random signal from one of the random number circuits 24. The probability control circuit 46 permits update of the synaptic weight with a probability generated on the basis of the received random signal and prohibits update of the synaptic weight unless the synaptic weight is permitted to be updated.

For example, the random signal represents a random number in a numerical range from a predetermined lower limit value to a predetermined upper limit value. In this case, the probability control circuit 46 permits update of the synaptic weight when a value of the random signal falls within a range corresponding to a predetermined first probability and prohibits update of the synaptic weight when the value of the random signal falls outside the range corresponding to the first probability.

For example, assume that the random signal represents a random number in a numerical range from 0 to (N-1) and that the first probability is p. Note that p is a real number larger than 0 and smaller than 1. In this case, for example, when the random signal has a value smaller than (p×N) or a value larger than (N−p×N) in the numerical range from 0 to (N-1), the probability control circuit 46 may permit update of the synaptic weight by determining the value of the random signal as falling within the range corresponding to the first probability. Alternatively, when the random signal has a value preselected from P pieces of values in the numerical range from 0 to (N-1), the probability control circuit 46 may permit update of the synaptic weight by determining the value of the random signal as falling within the range corresponding to the first probability. Note that P is an integer of (p×N) of which the decimal portion is rounded down or up. This enables the probability control circuit 46 to permit update of the synaptic weight with a probability generated on the basis of the random signal.

For example, the probability control circuit 46 receives an update command signal commanding synaptic weight update operation to the storage circuit 42, from the update circuit 48. When permitting update of the synaptic weight, the probability control circuit 46 gives the synaptic weight update command signal received from the update circuit 48 to the storage circuit 42 as it is. When prohibiting update of the synaptic weight, the probability control circuit 46 masks the synaptic weight update command signal received from the update circuit 48 and does not give the signal to the storage circuit 42. This enables the probability control circuit 46 to control permission and prohibition of update of the synaptic weight by the update circuit 48.

The update circuit 48 receives the input signal from the pre-neuron circuit 32. The update circuit 48 also receives the feedback signal representing the operation or state of the post-neuron circuit 34 from the post-neuron circuit 34.

Upon receiving the input signal from the pre-neuron circuit 32, the update circuit 48 updates the synaptic weight stored in the storage circuit 42 in accordance with the feedback signal on condition that the probability control circuit 46 permits the update of the synaptic weight.

For example, when the synaptic weight is updated in accordance with the update rule based on STDP, the update circuit 48 performs the following operation. That is, the update circuit 48 receives the firing signal from the post-neuron circuit 34 as a feedback signal. When the time difference (Δt) from the input signal to the feedback signal is larger than 0 and smaller than the predetermined value (T), the update circuit 48 outputs an update command signal for increasing the synaptic weight. When the time difference (Δt) from the input signal to the feedback signal is equal to or smaller than 0 or equal to or larger than the predetermined value (T), the update circuit 48 outputs an update command signal for decreasing the synaptic weight.

For example, when the synaptic weight is updated in accordance with the update rule based on Fusi rule, the update circuit 48 performs the following operation. That is, the update circuit 48 receives the inner potential signal from the post-neuron circuit 34 as a feedback signal. When the input signal has the first value (for example, 1) indicating firing and when the feedback signal has the first value (for example, 1) indicating that the inner potential is equal to or larger than the predetermined value, the update circuit 48 outputs an update command signal for changing the synaptic weight in the increment direction. When the input signal has the second value (for example, 0) and when the feedback signal has the first value (for example, 1), the update circuit 48 outputs an update command signal for changing the synaptic weight in the decrement direction.

The update circuit 48 gives the update command signal via the probability control circuit 46 to the storage circuit 42. Therefore, the update circuit 48 can update the synaptic weight stored in the storage circuit 42 on condition that the probability control circuit 46 permits the update of the synaptic weight.

When the update command signal is received from the update circuit 48 via the probability control circuit 46, the storage circuit 42 changes the synaptic weight stored. For example, when the update command signal for changing the synaptic weight in the increment direction is received, the storage circuit 42 increases the synaptic weight stored. When the update command signal for changing the synaptic weight in the decrement direction is received, the storage circuit 42 decreases the synaptic weight stored.

However, the synaptic weight is represented by a discrete value and in a predetermined numerical range. Therefore, even when the update command signal for changing the synaptic weight in the increment direction is received, the storage circuit 42 does not change the synaptic weight to become equal to or larger than an upper limit value of the numerical range. Even when the update command signal for changing the synaptic weight in the decrement direction is received, the storage circuit 42 does not change the synaptic weight to become equal to or smaller than a lower limit value of the numerical range.

The synaptic weight is represented, for example, in binary as the first value (for example, 1) or the second value (for example, 0). In this case, when the update command signal for changing the synaptic weight in the increment direction is received in a state where the stored synaptic weight has the first value (for example, 1), the storage circuit 42 does not change the synaptic weight. When the update command signal for changing the synaptic weight in the decrement direction is received in a state where the stored synaptic weight has the second value (for example, 0), the storage circuit 42 does not change the synaptic weight.

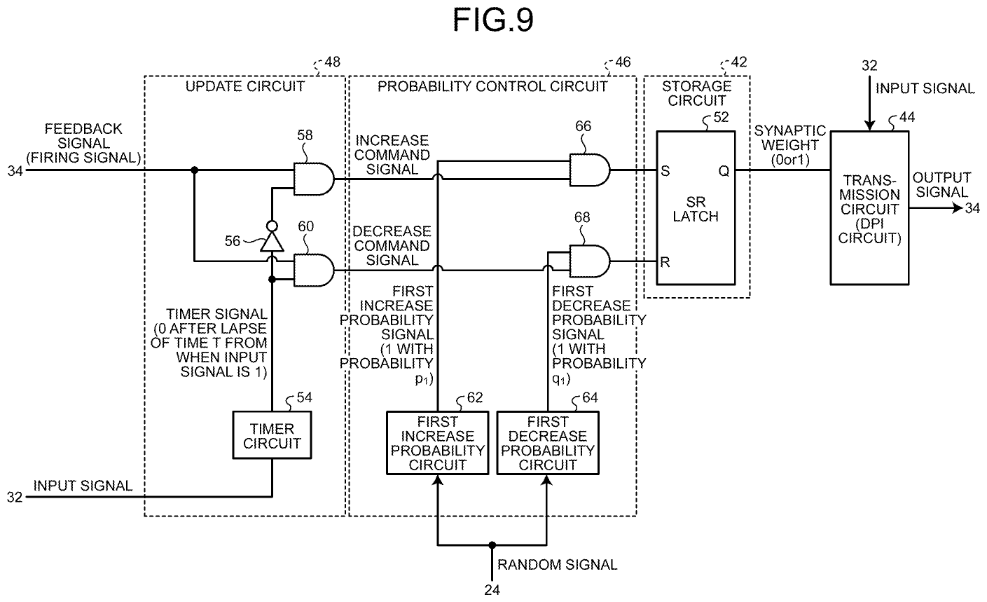

FIG. 9 is a diagram illustrating an example configuration of the storage circuit 42, the update circuit 48, and the probability control circuit 46 when the synaptic weight is updated in accordance with the stochastic update rule based on STDP.

The storage circuit 42 includes an SR latch circuit 52. The SR latch circuit 52 receives an increase command signal at a set pin and a decrease command signal at a reset pin. The increase command signal is the update command signal commanding a change of the synaptic weight in the increment direction and has the first value (for example, 1) when commanding a change of the synaptic weight in the increment direction. The decrease command signal is the update command signal for changing the synaptic weight in the decrement direction and has the first value (for example, 1) when commanding a change of the synaptic weight in the decrement direction.

The SR latch circuit 52 stores the synaptic weight representing the first value (for example, 1) or the second value (for example, 0). The SR latch circuit 52 outputs the stored synaptic weight from a Q pin to the transmission circuit 44.

When the synaptic weight is updated in accordance with the stochastic update rule based on STDP, the update circuit 48 includes a timer circuit 54, a first inverting circuit 56, a first AND circuit 58, and a second AND circuit 60.

The timer circuit 54 receives the input signal from the pre-neuron circuit 32. The timer circuit 54 outputs a timer signal representing 1 or 0. The timer circuit 54 sets the value of the timer signal at 1 for a period of time from timing at which the input signal is changed from 0 to 1 until a lapse of a predetermined period of time T and at 0 for the other period of time.

The first inverting circuit 56 receives the timer signal. The first inverting circuit 56 outputs an inverted timer signal in which the value of the timer signal is inverted.

The first AND circuit 58 receives the feedback signal being the firing signal output from the post-neuron circuit 34 and the inverted timer signal. The first AND circuit 58 computes the logical product of the feedback signal and the inverted timer signal. The first AND circuit 58 outputs the result of the computation of the logical product of the feedback signal and the inverted timer signal as the increase command signal.

The second AND circuit 60 receives the feedback signal being the firing signal output from the post-neuron circuit 34 and the timer signal. The second AND circuit 60 computes the logical product of the feedback signal and the timer signal. The second AND circuit 60 outputs the result of the computation of the logical product of the feedback signal and the timer signal as the decrease command signal.

The update circuit 48 with this configuration can output the increase command signal when the time difference (Δt) from the timing at which the input signal is changed from 0 to 1 to the timing at which the feedback signal is changed from 0 to 1 is smaller than the predetermined period of time T, at the timing at which the feedback signal is changed from 0 to 1. Moreover, the update circuit 48 can output the decrease command signal when the time difference (Δt) is equal to or larger than the predetermined period of time T at the timing at which the feedback signal is changed from 0 to 1.

The probability control circuit 46 includes a first increase probability circuit 62, a first decrease probability circuit 64, a third AND circuit 66, and a fourth AND circuit 68.

The first increase probability circuit 62 and the first decrease probability circuit 64 receive the random signal from one of the random number circuits 24. For example, the random signal represents a random number in the numerical range from 0 to (N-1) and periodically changes its value.

The first increase probability circuit 62 generates a first increase probability signal representing 1 with a probability of p₁ being a preset first increase probability and representing 0 with a probability of (1−p₁) on the basis of the received random signal. p₁ is a value larger than 0 and smaller than 1.

The first increase probability circuit 62 generates the first increase probability signal representing 1 when the value represented by the random signal is smaller than (p₁×N) or larger than (N−p₁×N) and representing 0 otherwise. Alternatively, the first increase probability circuit 62 may generate the first increase probability signal representing 1 when the value represented by the random signal is any of preselected P₁ pieces of values and representing 0 otherwise. Note that P₁ is an integer of (p₁×N) of which the decimal portion is rounded down or up.

The first decrease probability circuit 64 generates a first decrease probability signal representing 1 with a probability of q₁ being a preset first decrease probability and representing 0 with a probability of (1−q₁) on the basis of the received random signal. q₁ is a value larger than 0 and smaller than 1.

In this case, the first decrease probability circuit 64 generates the first decrease probability signal representing 1 when the value represented by the random signal is smaller than (q₁×N) or larger than (N−q₁×N) and representing 0 otherwise. Alternatively, the first decrease probability circuit 64 may generate the first decrease probability signal representing 1 when the value represented by the random signal is any of preselected Q₁ pieces of values and representing 0 otherwise. Note that Q₁ is an integer of (q₁×N) of which the decimal portion is rounded down or up.

The third AND circuit 66 receives the increase command signal output from the update circuit 48 and the first increase probability signal. The third AND circuit 66 computes the logical product of the increase command signal and the first increase probability signal. The third AND circuit 66 outputs the result of the computation of the logical product of the increase command signal and the first increase probability signal to the set pin of the storage circuit 42, as the increase command signal.

The fourth AND circuit 68 receives the decrease command signal output from the update circuit 48 and the first decrease probability signal. The fourth AND circuit 68 computes the logical product of the decrease command signal and the first decrease probability signal. The fourth AND circuit 68 outputs the result of the computation of the logical product of the decrease command signal and the first decrease probability signal to the reset pin of the storage circuit 42, as the decrease command signal.

This probability control circuit 46 can give the increase command signal output from the update circuit 48 to the storage circuit 42 with a probability of p₁ and mask the increase command signal with a probability of (1−p₁). This enables the probability control circuit 46 to permit a change of the synaptic weight in the increment direction by the update circuit 48 with the first increase probability p₁ generated on the basis of the random signal. The probability control circuit 46 can prohibit a change of the synaptic weight in the increment direction unless the synaptic weight is permitted to be changed in the increment direction.

Moreover, the probability control circuit 46 can give the decrease command signal output from the update circuit 48 to the storage circuit 42 with a probability of q₁ and mask the decrease command signal with a probability of (1−q₁). This enables the probability control circuit 46 to permit a change of the synaptic weight in the decrement direction by the update circuit 48 with the first decrease probability q₁ generated on the basis of the random signal. The probability control circuit 46 can prohibit a change of the synaptic weight in the decrement direction unless the synaptic weight is permitted to be changed in the decrement direction.

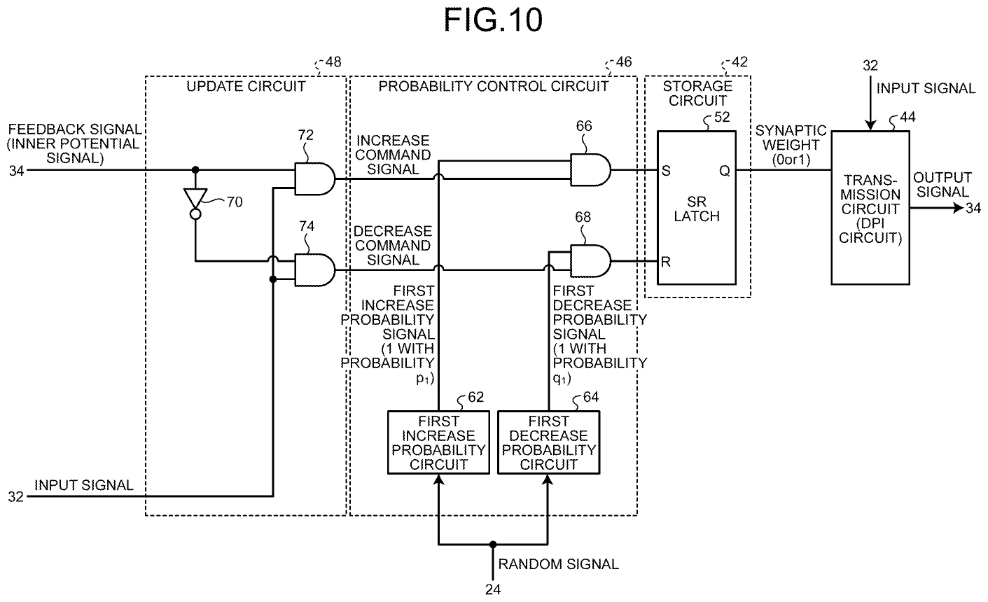

FIG. 10 is a diagram illustrating an example configuration of the storage circuit 42, the update circuit 48, and the probability control circuit 46 when the synaptic weight is updated in accordance with the stochastic update rule based on Fusi rule.

When the synaptic weight is updated in accordance with the stochastic update rule based on Fusi rule, the storage circuit 42 and the probability control circuit 46 have the same configuration as that illustrated in FIG. 9.

When the synaptic weight is updated in accordance with the stochastic update rule based on Fusi rule, the update circuit 48 includes a second inverting circuit 70, a fifth AND circuit 72, and a sixth AND circuit 74.

The second inverting circuit 70 receives the feedback signal being the inner potential signal output from the post-neuron circuit 34. The second inverting circuit 70 outputs an inverted feedback signal in which the value of the feedback signal is inverted.

The fifth AND circuit 72 receives the input signal output from the pre-neuron circuit 32 and the feedback signal. The fifth AND circuit 72 computes the logical product of the input signal and the feedback signal. The fifth AND circuit 72 outputs the result of the computation of the logical product of the input signal and the feedback signal as the increase command signal.

The sixth AND circuit 74 receives the input signal output from the pre-neuron circuit 32 and the inverted feedback signal. The sixth AND circuit 74 computes the logical product of the input signal and the inverted feedback signal. The sixth AND circuit 74 outputs the result of the computation of the logical product of the input signal and the inverted feedback signal as the decrease command signal.

The update circuit 48 with this configuration can output the update command signal for changing the synaptic weight in the increment direction when the input signal represents 1 and when the feedback signal represents 1. Moreover, the update circuit 48 can output the update command signal for changing the synaptic weight in the decrement direction when the input signal represents 0 and when the feedback signal represents 1.

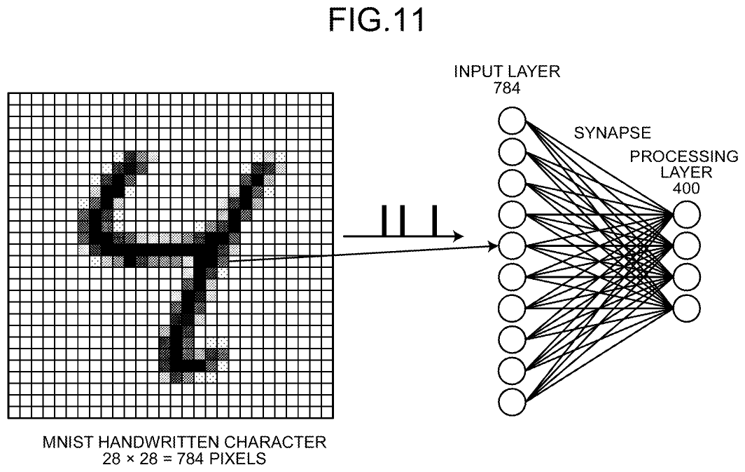

FIG. 11 is a diagram illustrating an MNIST handwritten character and a spiking neural network.

Herein, learning of an MNIST handwritten character of 784 (=28×28) pixels by a spiking neural network is investigated. The spiking neural network to be investigated includes an input layer and a processing layer in a stage subsequent to the input layer. The input layer includes 784 neurons. The processing layer includes 400 neurons. The 784 neurons included in the input layer and the 400 neurons included in the processing layer are connected via multiple synapses.

The 784 neurons included in the input layer acquire contrast of the 784 pixels included in the MNIST handwritten character. The 784 neurons included in the input layer generate spike trains with spike densities corresponding to the contrast of the 784 pixels and send voltage spikes to each of the 400 neurons included in the processing layer via the synapses.

The synaptic weight update rule in the spiking neural network to be investigated is the stochastic update rule according to STDP illustrated in FIG. 5. The probability p of increasing the synaptic weight from 0 to 1 is, for example, approximately 0.01. The probability q of decreasing the synaptic weight from 1 to 0 is, for example, approximately 0.001. The spiking neural network to be investigated is designed such that multiple neurons do not simultaneously fire.

Each of the synapses in the spiking neural network to be investigated controls the probability on the basis of a random signal generated by a probability generator.

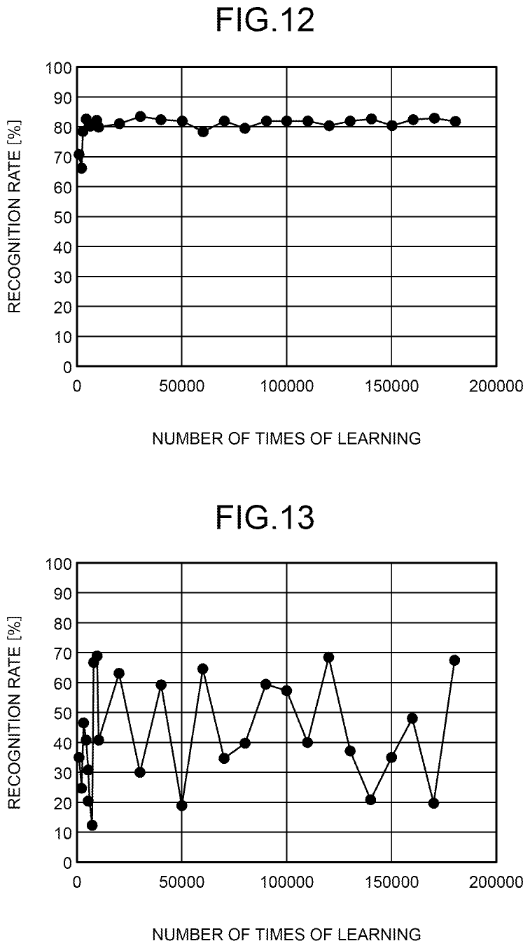

FIG. 12 is a diagram illustrating a result of recognition rate simulation when the spiking neural network illustrated in FIG. 11 has such a configuration that all the synapses receive the random signals from mutually independent probability generators.

The spiking neural network illustrated in FIG. 11 has such a configuration that all the synapses receive the random signals from mutually independent probability generators. When this spiking neural network learns the MNIST handwritten character for pattern recognition, the recognition rates relative to the numbers of times of learning exceed 80% as illustrated in FIG. 12.

FIG. 13 is a diagram illustrating a result of recognition rate simulation when the spiking neural network illustrated in FIG. 11 has such a configuration that all the synapses receive the random signals from a single common probability generator.

The spiking neural network illustrated in FIG. 11 has such a configuration that all the synapses receive the random signals from a single common probability generator. When this spiking neural network learns the MNIST handwritten character for pattern recognition, the recognition rates relative to the numbers of times of learning never exceed 70% as illustrated in FIG. 13. Moreover, in this case, the recognition rates relative to the numbers of times of learning are unstable relative to the numbers of times of learning. Therefore, in this case, the spiking neural network cannot learn correctly.

Note that the random signals change temporally. Each of the synapses updates the weight at different timing. Therefore, even in the case illustrated in FIG. 13, the probability signal representing permission or prohibition of update of the synaptic weight at update timing differs for each synapse.

From the above, in the spiking neural network adopting the update rule stochastically updating the synaptic weights, all the synapses preferably control the probabilities on the basis of the random signals generated from mutually independent probability generators, on comparison between FIGS. 12 and 13.

The probability generator generates a random signal that varies temporally and randomly. As such a probability generator, pseudo random number generating circuits are known. A linear feedback shift register (LFSR) circuit being a typical pseudo random number generating circuit can be produced using a general silicon CMOS digital circuit technique. The LFSR circuit uses a large number of shift registers. The LFSR circuit therefore includes a large number of transistors and has a large footprint.

Hence, the spiking neural network including mutually independent LFSR circuits for all the synapses and configured by hardware increases in circuitry scale. For example, when the synaptic weight update probability is approximately 0.001, the LFSR circuits should have a period of 1023 or larger. An LFSR circuit whose period is 1023 or larger requires approximately 160 transistors when implemented as hardware. The number of the transistors in this LFSR circuit is significantly large in comparison to the number of transistors in a circuit for synapse signal transmission. Therefore, when the spiking neural network adopting the update rule stochastically updating the synaptic weights is implemented by hardware, it is desirable to reduce the number of the probability generators to reduce the circuitry scale.

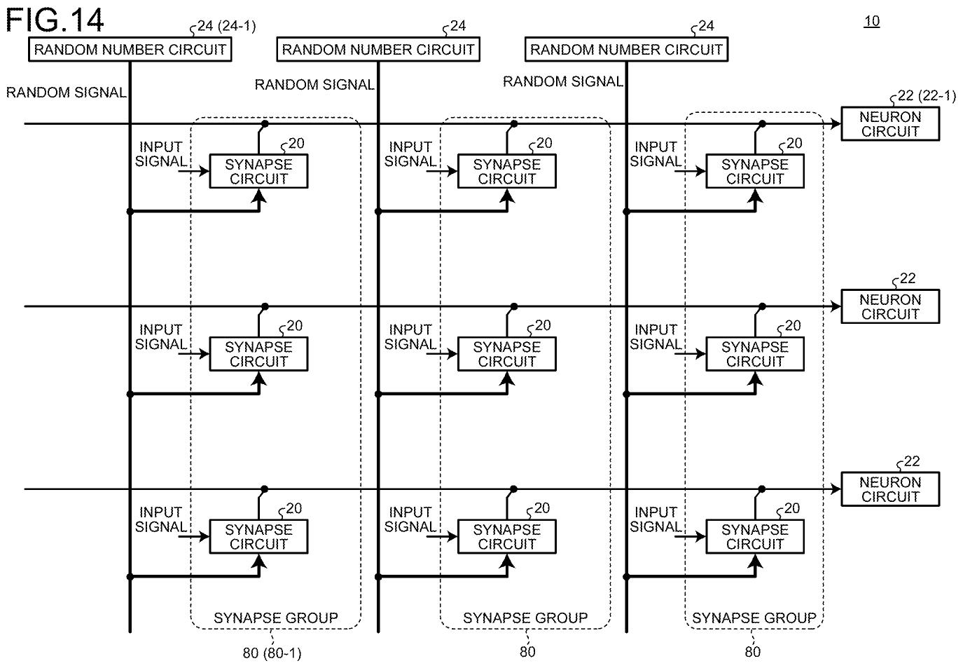

FIG. 14 is a diagram illustrating a first connection example of the neural network device 10 according to the first embodiment.

The synapse circuits 20 are divided into synapse groups 80. Each of the synapse groups 80 includes two or more synapse circuits 20. Each of the synapse groups 80 corresponds to one of the random number circuits 24.

Each of the two or more synapse circuits 20 belonging to one of the synapse groups 80 receives the random signal output from one of the random number circuits 24. In other words, each of the two or more synapse circuits 20 belonging to the same synapse group 80 receives the random signal output from the same random number circuit 24. For example, each of the two or more synapse circuits 20 belonging to a first synapse group 80-1 in the synapse groups 80 receives the random signal output from a first random number circuit 24-1 in the random number circuits 24.

Each of the neuron circuits 22 receives two or more synapse signals from two or more synapse circuits 20 belonging to mutually different synapse groups 80. In other words, the two or more synapse circuits 20 outputting the output signals to one of the neuron circuits 22 belong to mutually different synapse groups 80. For example, each of the two or more synapse circuits 20 outputting the output signals to a first neuron circuit 22-1 in the neuron circuits 22 belongs to the synapse group 80 differing from those for the other synapse circuits 20 outputting the output signals to the first neuron circuit 22-1.

In this neural network device 10 of the first embodiment, one neuron circuit 22 is focused on. The focused neuron circuit 22 learns the informational relationships between itself and the connected pre-neuron circuits 32 through synaptic weight adjustment. In this case, the pre-neuron circuits 32 have mutually independent information. Therefore, the focused neuron circuit 22 should learn the informational relationship between itself and the pre-neuron circuits 32 independently of each other, not synchronously with each other.

In the neural network device 10 of the first embodiment, each of the two or more synapse circuits 20 outputting the output signals to the first neuron circuit 22-1 belongs to the synapse group 80 differing from those for the other synapse circuits 20 outputting the output signals to the first neuron circuit 22-1. Therefore, each of the two or more synapse circuits 20 outputting the output signals to the first neuron circuit 22-1 stochastically updates the synaptic weight on the basis of the random signal output from the random number circuit 24 differing from those for the other synapse circuits 20 outputting the output signals to the first neuron circuit 22-1. Therefore, the neural network device 10 of the first embodiment can learn the informational relationship between the first neuron circuit 22-1 and the pre-neuron circuits 32 independently of each other. This enables the neural network device 10 of the first embodiment to appropriately learn the synaptic weight assigned to each of the synapse circuits 20.

Moreover, the neural network device 10 of the first embodiment includes the random number circuit 24 for each of the synapse groups 80. Therefore, the neural network device 10 of the first embodiment enables reduction in the number of the synapse circuits 20 and can therefore be implemented with small-scale circuitry.

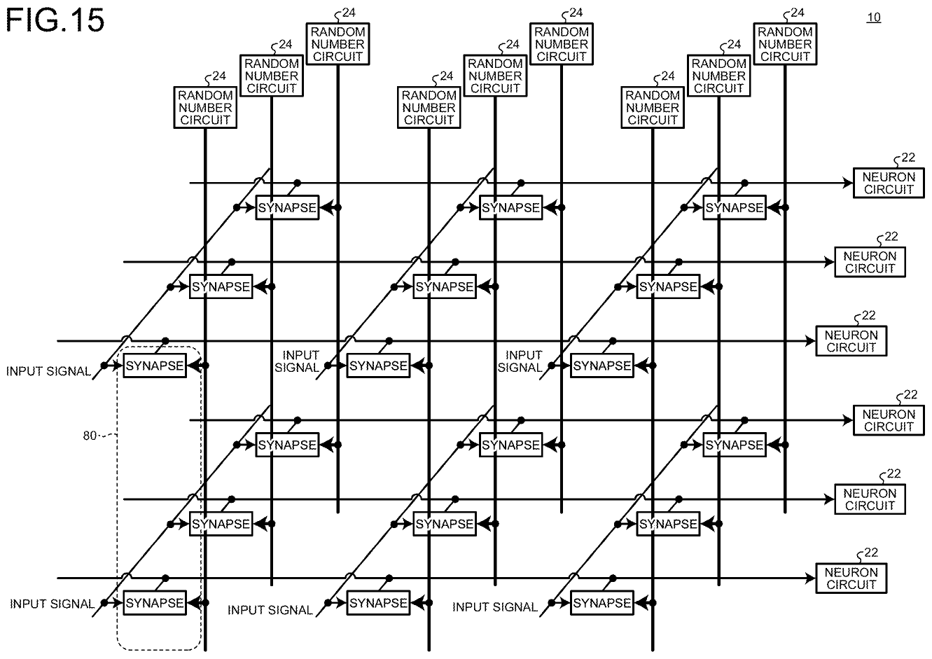

FIG. 15 is a diagram illustrating a second connection example of the neural network device 10 according to the first embodiment.

In the neural network device 10 of the first embodiment, for example, the synapse circuits 20 may be arranged three-dimensionally in multiple layers. In the neural network device 10, two or more neuron circuits 22 are arranged in each of the layers.

In this case, each of the synapse circuits 20 supplies the output signal to the neuron circuits 22 arranged in the same layer. In the synapse circuits 20, the two or more synapse circuits 20 arranged in the same layer may acquire the firing signal output from the same neuron circuit 22 as an input signal.

In this case, each of the synapse groups 80 includes two or more synapse circuits 20 arranged in mutually different layers.

In this neural network device 10 in the second connection example of the first embodiment, the random number circuits 24 can be arranged in a layer differing from the layers where the synapse circuits 20 are arranged. Each of the random number circuits 24 can supply the random signal to the two or more synapse circuits 20 through the layers.

This neural network device 10 in the second connection example of the first embodiment enables efficient arrangement of the synapse circuits 20, the neuron circuits 22, and the random number circuits 24.

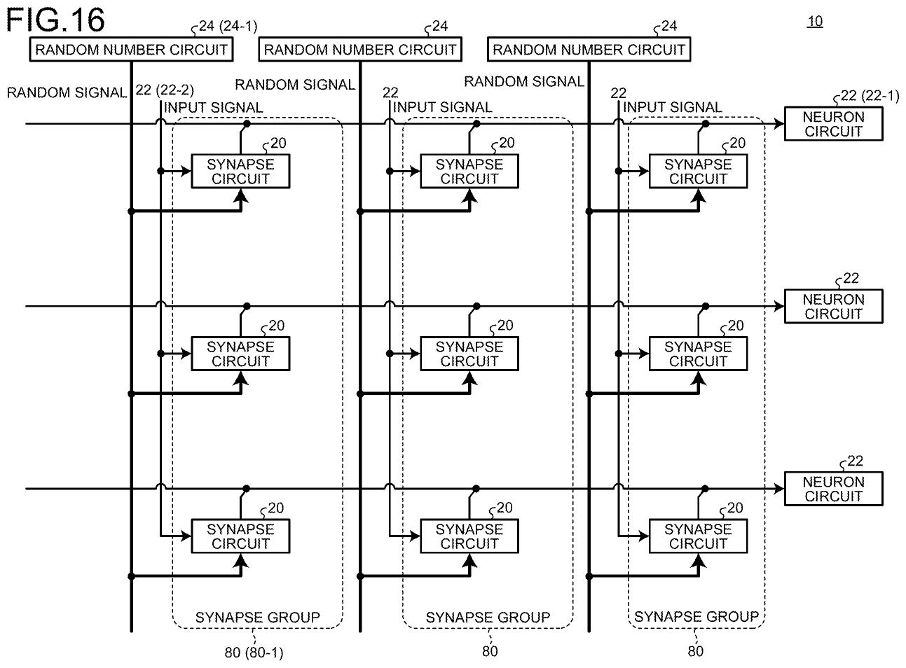

FIG. 16 is a diagram illustrating a third connection example of the neural network device 10 according to the first embodiment.

The third connection example of the first embodiment has substantially the same configuration as that of the first connection example illustrated in FIG. 14. Therefore, the third connection example of the first embodiment is described in terms of differences from the first connection example illustrated in FIG. 14.

In the third connection example, each of the two or more synapse circuits 20 belonging to one of the synapse groups 80 receives the firing signal output from one of the neuron circuits 22 as an input signal. In other words, each of the two or more synapse circuits 20 belonging to the same synapse group 80 receives the firing signal output from the same neuron circuit 22 as an input signal.

For example, each of the two or more synapse circuits 20 belonging to the first synapse group 80-1 in N pieces of the synapse groups 80 receives the firing signal output from a second neuron circuit 22-2 in the neuron circuits 22 as an input signal.

This neural network device 10 in the third connection example of the first embodiment enables efficient connection of wiring transmitting the input signals.

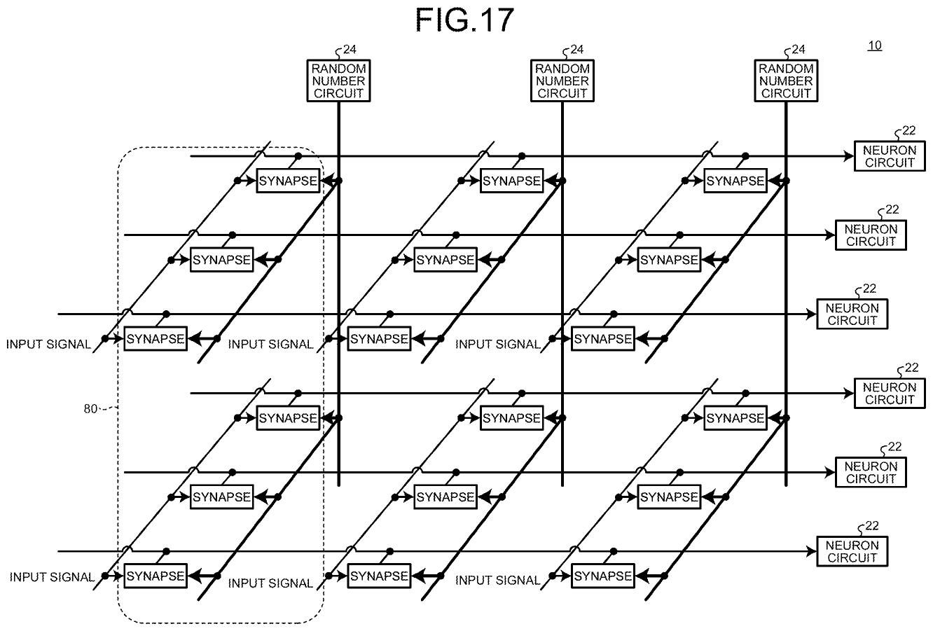

FIG. 17 is a diagram illustrating a fourth connection example of the neural network device 10 according to the first embodiment.

The fourth connection example of the first embodiment has substantially the same configuration as that of the second connection example illustrated in FIG. 15. Therefore, the fourth connection example of the first embodiment is described in terms of differences from the second connection example illustrated in FIG. 15.

In the fourth connection example, each of the two or more synapse circuits 20 belonging to one of the synapse groups 80 receives the firing signal output from one of the neuron circuits 22 as an input signal. In other words, each of the two or more synapse circuits 20 belonging to the same synapse group 80 receives the firing signal output from the same neuron circuit 22 as an input signal.

This neural network device 10 in the fourth connection example of the first embodiment enables efficient arrangement of the synapse circuits 20, the neuron circuits 22, and the random number circuits 24, and efficient connection of wiring transmitting the input signals.

Moreover, in the fourth connection example, each of the synapse groups 80 includes two or more synapse circuits 20 that are included in the same layer and that output signals to mutually different neuron circuits 22. Therefore, the neural network device 10 in the fourth connection example of the first embodiment enables further reduction in the number of the random number circuits 24.

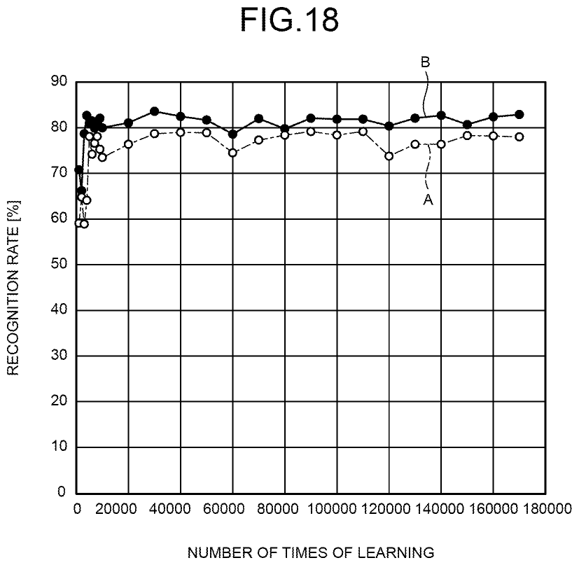

FIG. 18 is a diagram illustrating a result of recognition rate simulation of the neural network device 10 of the first embodiment. Note that a line A in FIG. 18 represents recognition rates when the spiking neural network illustrated in FIG. 11 is configured according to the third connection example of the first embodiment. A line B in FIG. 18 represents recognition rates when the spiking neural network illustrated in FIG. 11 has such a configuration that all the synapses receive the random signals from mutually independent probability generators.

When the spiking neural network configured according to the third connection example of the first embodiment learns the MNIST handwritten character for pattern recognition, the recognition rates relative to the numbers of times of learning are close to 80% as illustrated by A in FIG. 18. The recognition rates A in FIG. 18 are lower than but very close to the recognition rates illustrated by B in FIG. 18 when all the synapses receive the random signals from mutually independent probability generators. The recognition rates A in FIG. 18 are stable relative to the numbers of times of learning. Therefore, the spiking neural network in FIG. 11 configured according to the third connection example of the first embodiment can learn accurately.

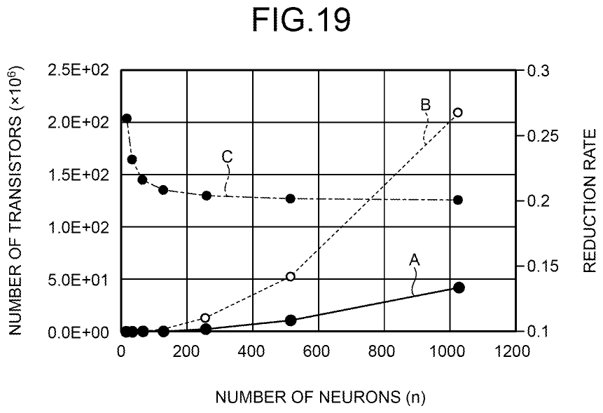

FIG. 19 is a diagram illustrating the numbers of transistors relative to the number of neurons. Note that a line A in FIG. 19 represents the numbers of transistors in the spiking neural network configured according to the third connection example of the first embodiment. A line B in FIG. 19 represents the numbers of transistors in the spiking neural network having such a configuration that all the synapses receive the random signals from mutually independent probability generators. A line C in FIG. 19 represents (B−A)/A being rates of reduction in the numbers of transistors.

For example, the synapse circuit 20 illustrated in FIG. 9 or 10 can be composed of approximately 40 transistors. When the synapse circuit 20 illustrated in FIG. 10 is adopted, each of the neuron circuits 22 includes a comparator circuit for comparing the magnitude of the inner potential with a threshold potential. The comparator circuit can be composed of approximately 16 transistors.

Assume that each of the random number circuits 24 of the first embodiment is an LFSR circuit whose period is 1023. Assume that the probability generators in the spiking neural network, illustrated in FIG. 11, having such a configuration that all the synapses receive the random signals from mutually independent probability generators are also LFSR circuits whose period is 1023. An LFSR circuit whose period is 1023 can be composed of approximately 160 transistors.

Let n (n is an integer of 2 or larger) represent the number of neurons in the input layer of the spiking neural network illustrated in FIG. 11.

In this case, when the spiking neural network is configured as illustrated in FIG. 11, the numbers of transistors in the configuration according to the third connection example of the first embodiment (A in FIG. 19) are smaller than those in the configuration in which all the synapses receive the random signals from mutually independent probability generators (B in FIG. 19). As illustrated by C in FIG. 19, the reduction rates are approximately 20%.

As described above, the neural network device 10 of the first embodiment is a spiking neural network configured by hardware and can update the synaptic weights according to the stochastic update rule. The neural network device 10 of the first embodiment enables appropriate arrangement while reducing the number of the random number circuits 24 and can therefore learn accurately with small-scale circuitry. Therefore, the neural network device 10 of the first embodiment can perform accurate inference with small-scale circuitry.

### Second Embodiment

Next, a neural network device 10 according to a second embodiment will be described. Note that the neural network device 10 of the second embodiment has substantially the same functions and configuration as those in the first embodiment. Therefore, constituents having substantially the same functions and configuration are denoted by the same reference signs, and their detailed description is omitted except differences.

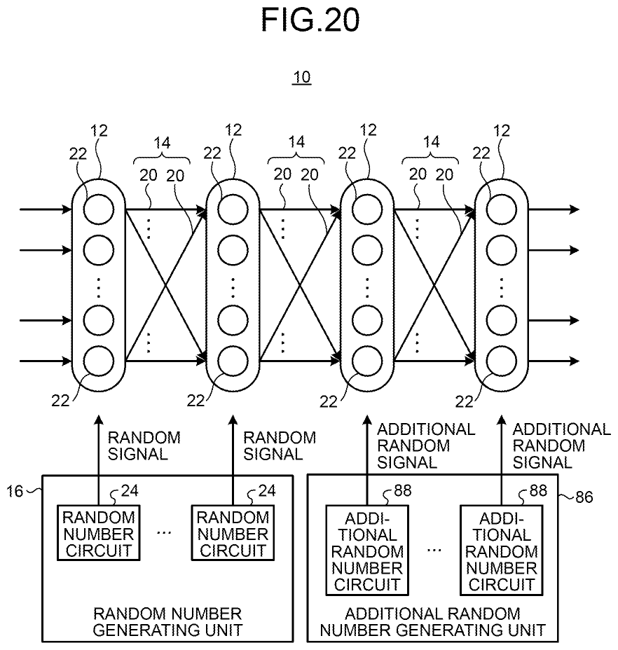

FIG. 20 is a diagram illustrating an example configuration of the neural network device 10 according to the second embodiment. The neural network device 10 of the second embodiment includes, for example, the N-stage (N is an integer of 2 or larger) layers 12, the (N-1) pieces of synapse units 14, the random number generating unit 16, and an additional random number generating unit 86. In other words, in comparison to the configuration of the first embodiment illustrated in FIG. 1, the neural network device 10 of the second embodiment further includes the additional random number generating unit 86.

The additional random number generating unit 86 includes a plurality of additional random number circuits 88. Each of the additional random number circuits 88 outputs an additional random signal representing a random number periodically changed. Each of the additional random number circuits 88 is independent of the other additional random number circuits 88 and the random number circuits 24 in terms of circuits and generates an additional random signal representing a random number differing from those from the random number circuits 24 and the other additional random number circuits 88. Each of the additional random number circuits 88 is, for example, a pseudo random number generating circuit.

The random number represented by the additional random signal is a value in a predetermined range. For example, the random number represented by the additional random signal is a value in the range of 10-bit width (0 to 1023).

The additional random number circuits 88 correspond to one of the neuron circuits 22. For example, the additional random number circuits 88 and the neuron circuits 22 have a one-to-one correspondence. Note that each of the additional random number circuits 88 may correspond to two or more neuron circuits 22. However, each of the neuron circuits 22 corresponds to one of the additional random number circuits 88.

While the neural network device 10 illustrated in FIG. 20 has a layered structure, the neural network device 10 of the second embodiment may be a recurrent neural network illustrated in FIG. 2.

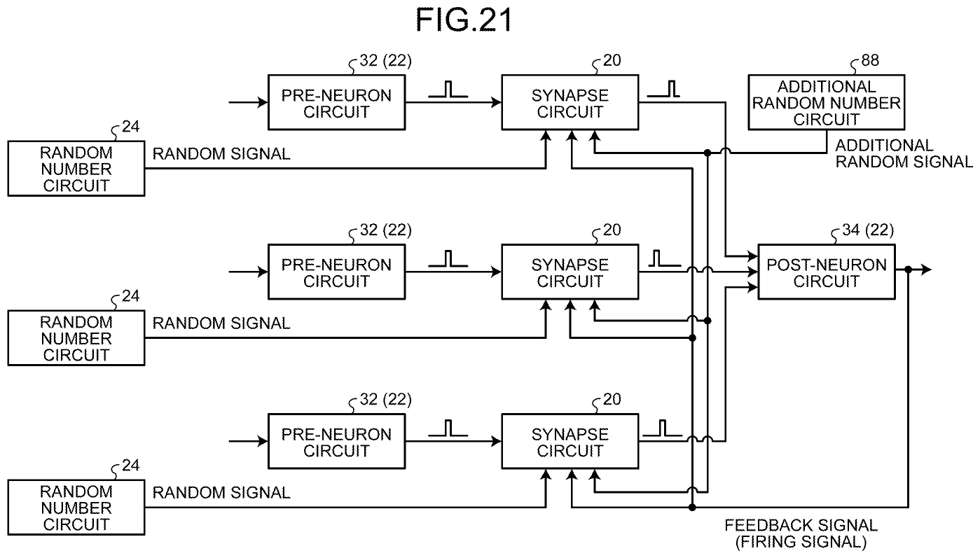

FIG. 21 is a diagram illustrating a connection relationship between the synapse circuits 20 and other circuits according to the second embodiment.

Each of the synapse circuits 20 further receives the additional random signal output from one of the additional random number circuits 88. For example, each of the synapse circuits 20 receives the additional random signal from the additional random number circuit 88 corresponding to the neuron circuit 22 to which the synapse circuit 20 outputs the output signal, among the additional random number circuits 88. In other words, each of the additional random number circuits 88 outputs the additional random signal to the two or more synapse circuits 20 from which the corresponding neuron circuit 22 receives the output signals, among the synapse circuits 20.

Each of the synapse circuits 20 then stochastically updates the assigned synaptic weight in accordance with a predetermined synapse update rule with a probability obtained by multiplying a predetermined first probability generated on the basis of the received random signal by a predetermined second probability generated on the basis of the additional random signal. The first probability is larger than the second probability.

Note that FIG. 21 illustrates the connection relationship between the synapse circuits 20 and other circuits when the synaptic weights are updated in accordance with the stochastic update rule based on STDP; however, the connection relationship between the additional random number circuits 88 and the synapse circuits 20 is similar even in the case of Fusi rule.

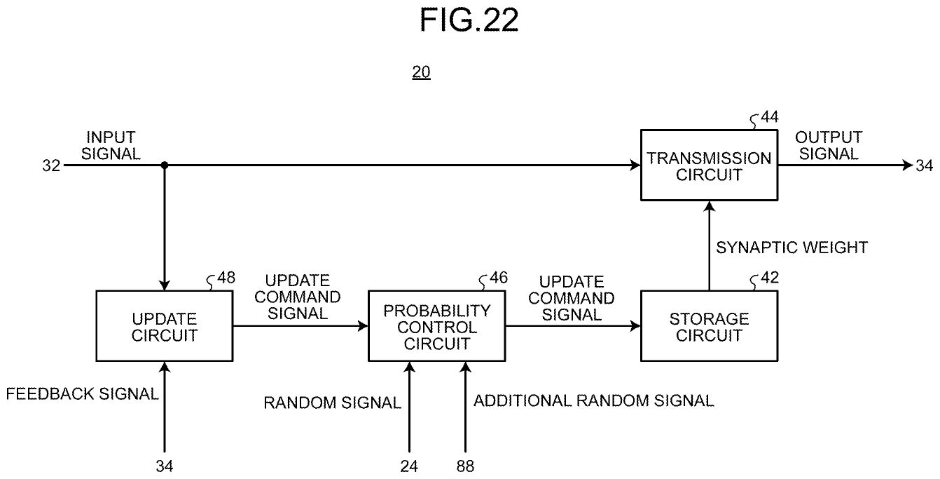

FIG. 22 is a diagram illustrating a configuration of the synapse circuit 20 according to the second embodiment. In the second embodiment, the probability control circuit 46 receives the additional random signal from one of the additional random number circuits 88.

The probability control circuit 46 permits update of the synaptic weight with a probability obtained by multiplying the first probability generated on the basis of the received random signal by the second probability generated on the basis of the received additional random signal and prohibits update of the synaptic weight unless the synaptic weight is permitted to be updated.

For example, the random signal represents a random number in a numerical range from a predetermined first lower limit value to a predetermined first upper limit value. For example, the additional random signal represents a random number in a numerical range from a predetermined second lower limit value to a predetermined second upper limit value.

In this case, the probability control circuit 46 permits update of the synaptic weight when a value of the random signal falls within a range corresponding to the predetermined first probability and a value of the additional random signal falls within a range corresponding to the predetermined second probability. The probability control circuit 46 prohibits update of the synaptic weight when the value of the random signal falls outside the range corresponding to the predetermined first probability or when the value of the additional random signal falls outside the range corresponding to the predetermined second probability.

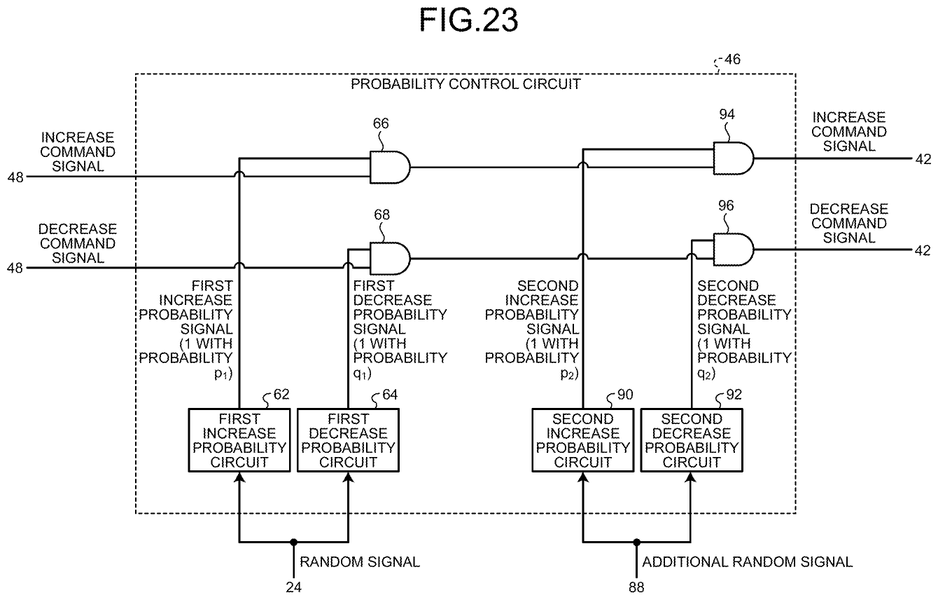

FIG. 23 is a diagram illustrating a configuration of the probability control circuit 46 according to the second embodiment.

The probability control circuit 46 of the second embodiment includes the first increase probability circuit 62, the first decrease probability circuit 64, the third AND circuit 66, the fourth AND circuit 68, a second increase probability circuit 90, a second decrease probability circuit 92, a seventh AND circuit 94, and an eighth AND circuit 96. In other words, in comparison to the configuration of the first embodiment illustrated in FIG. 9, the probability control circuit 46 of the second embodiment further includes the second increase probability circuit 90, the second decrease probability circuit 92, the seventh AND circuit 94, and the eighth AND circuit 96.

The second increase probability circuit 90 and the second decrease probability circuit 92 receive the additional random signal from one of the additional random number circuits 88. For example, the additional random signal represents a random number in the numerical range from 0 to (N-1) and periodically changes its value.

The second increase probability circuit 90 generates a second increase probability signal representing 1 with a preset second increase probability of p₂ and representing 0 with a probability of (1−p₂) on the basis of the received additional random signal. p₂ is a value larger than 0 and smaller than 1.

The second increase probability circuit 90 generates the second increase probability signal representing 1 when the value represented by the additional random signal is smaller than (p₂×N) or larger than (N−p₂×N) and representing 0 otherwise. Alternatively, the second increase probability circuit 90 may generate the second increase probability signal representing 1 when the value represented by the additional random signal is any of preselected P₂ pieces of values and representing 0 otherwise. Note that P₂ is an integer of (p₂×N) of which the decimal portion is rounded down or up.

The second decrease probability circuit 92 generates a second decrease probability signal representing 1 with a preset second decrease probability of q₂ and representing 0 with a probability of (1−q₂) on the basis of the received additional random signal. q₂ is a value larger than 0 and smaller than 1.

In this case, the second decrease probability circuit 92 generates the second decrease probability signal representing 1 when the value represented by the additional random signal is smaller than (q₂×N) or larger than (N−q₂×N) and representing 0 otherwise. Alternatively, the second decrease probability circuit 92 may generate the second decrease probability signal representing 1 when the value represented by the additional random signal is any of preselected Q₂ pieces of values and representing 0 otherwise. Note that Q₂ is an integer of (q₂×N) of which the decimal portion is rounded down or up.

The seventh AND circuit 94 receives the signal output from the third AND circuit 66 and the second increase probability signal. The seventh AND circuit 94 computes the logical product of the signal output from the third AND circuit 66 and the second increase probability signal. The seventh AND circuit 94 outputs the result of the computation of the logical product of the signal output from the third AND circuit 66 and the second increase probability signal to the set pin of the storage circuit 42, as the increase command signal.

The eighth AND circuit 96 receives the signal output from the fourth AND circuit 68 and the second decrease probability signal. The eighth AND circuit 96 computes the logical product of the signal output from the fourth AND circuit 68 and the second decrease probability signal. The eighth AND circuit 96 outputs the result of the computation of the logical product of the signal output from the fourth AND circuit 68 and the second decrease probability signal to the reset pin of the storage circuit 42, as the decrease command signal.

This probability control circuit 46 of the second embodiment can give the increase command signal output from the update circuit 48 to the storage circuit 42 with a probability of (p₁×p₂) and mask the increase command signal with a probability of (1−(p₁×p₂)). This enables the probability control circuit 46 to permit a change of the synaptic weight in the increment direction by the update circuit 48 with the probability obtained by multiplying the first increase probability p₁ generated on the basis of the random signal by the second increase probability p₂ generated on the basis of the additional random signal. The probability control circuit 46 can prohibit a change of the synaptic weight in the increment direction unless the synaptic weight is permitted to be changed in the increment direction.

Moreover, the probability control circuit 46 can give the decrease command signal output from the update circuit 48 to the storage circuit 42 with a probability of (q₁×q₂) and mask the decrease command signal with a probability of (1−(q₁× q₂)). This enables the probability control circuit 46 to permit a change of the synaptic weight in the decrement direction by the update circuit 48 with the probability obtained by multiplying the first decrease probability q₁ generated on the basis of the random signal by the second decrease probability q₂ generated on the basis of the additional random signal. The probability control circuit 46 can prohibit a change of the synaptic weight in the decrement direction unless the synaptic weight is permitted to be changed in the decrement direction.

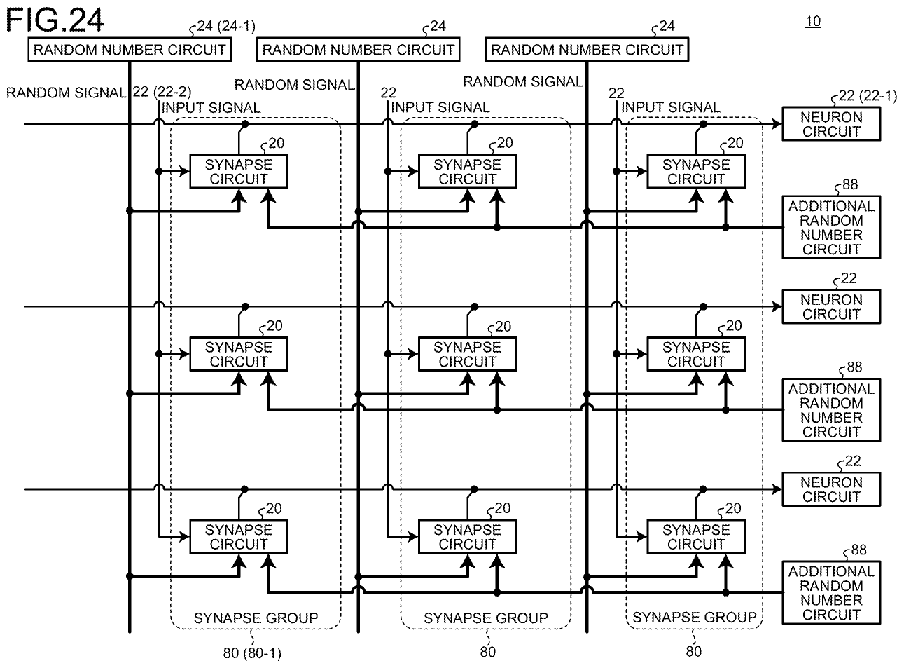

FIG. 24 is a diagram illustrating a first connection example of the neural network device 10 according to the second embodiment.

Each of the neuron circuits 22 corresponds to one of the additional random number circuits 88. For example, the neuron circuits 22 and the additional random number circuits 88 have a one-to-one correspondence.

Each of the additional random number circuits 88 supplies the additional random signal to two or more synapse circuits 20 supplying the output signals to the corresponding one of the neuron circuits 22. In other words, the two or more synapse circuits 20 belonging to one of the synapse groups 80 receive the additional random signals from mutually different additional random number circuits 88.

This enables each of the synapse circuits 20 to update the synaptic weight independently of the other synapse circuits 20 belonging to the same synapse group 80 in terms of probabilities.

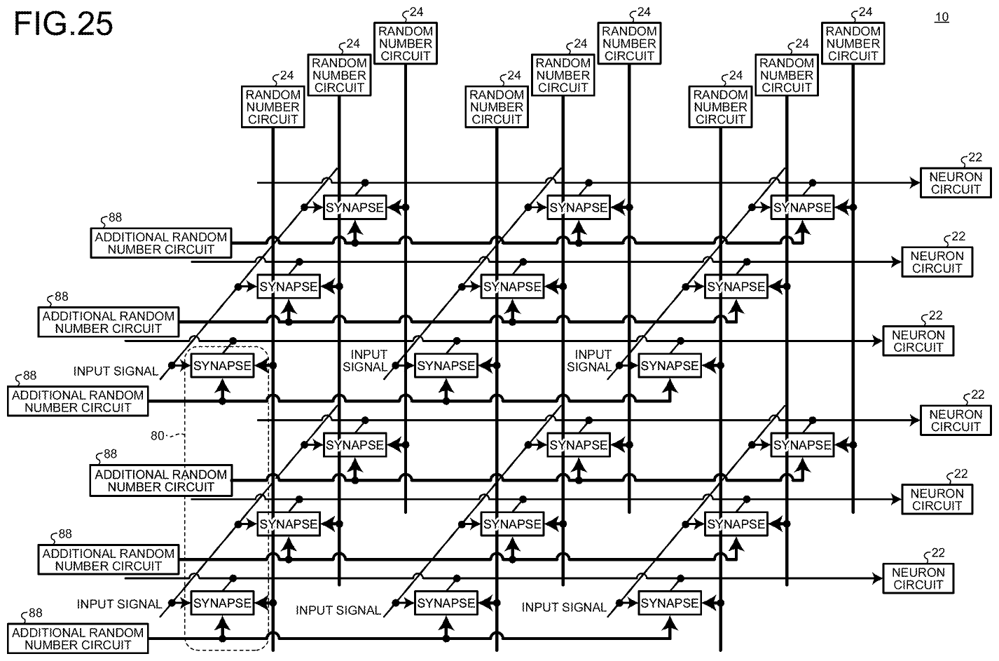

FIG. 25 is a diagram illustrating a second connection example of the neural network device 10 according to the second embodiment.

In the neural network device 10 of the second embodiment, for example, the synapse circuits 20 may be arranged three-dimensionally in multiple layers.

The synapse circuits 20, the neuron circuits 22, and the random number circuits 24 in the neural network device 10 in the second connection example of the second embodiment are arranged in the same manner as those in the second connection example of the first embodiment in FIG. 15.

In the second connection example of the second embodiment, the additional random number circuits 88 are arranged in each of the layers in correspondence with the neuron circuits 22.

In this case, each of the synapse circuits 20 supplies the output signal to the neuron circuits 22 arranged in the same layer. Each of the two or more synapse circuits 20 arranged in the same layer may acquire the firing signal output from the same neuron circuit 22 as an input signal.

In this case, each of the synapse groups 80 includes two or more synapse circuits 20 arranged in mutually different layers.

In this neural network device 10 in the second connection example of the second embodiment, the random number circuits 24 can be arranged in a layer differing from the layers where the synapse circuits 20 are arranged. Each of the random number circuits 24 supplies the random signal to the corresponding two or more synapse circuits 20 through the layers.

This neural network device 10 in the second connection example of the second embodiment enables efficient arrangement of the synapse circuits 20, the neuron circuits 22, the random number circuits 24, and the additional random number circuits 88.

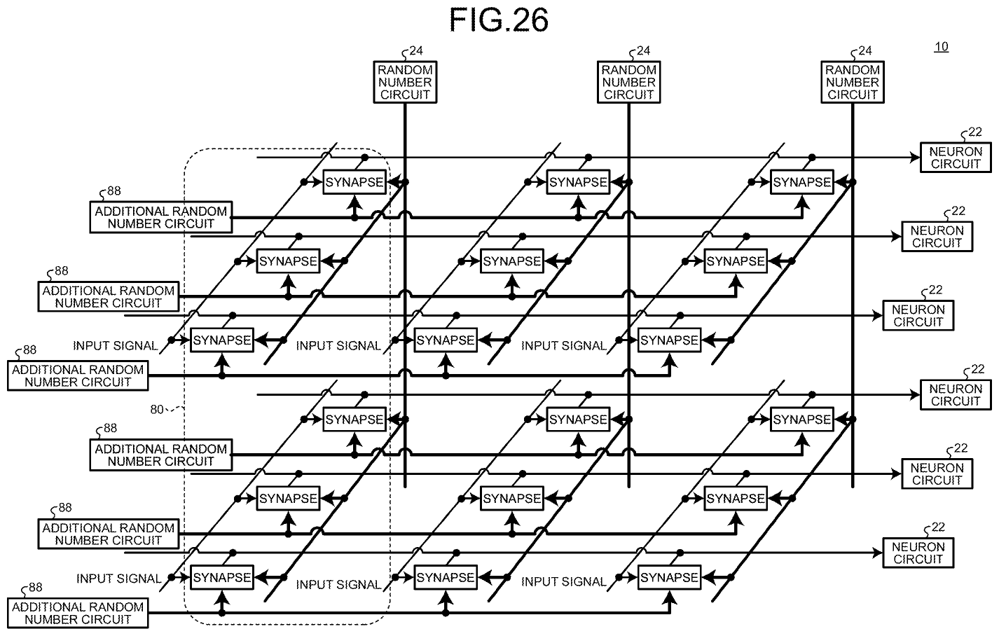

FIG. 26 is a diagram illustrating a third connection example of the neural network device 10 according to the second embodiment.

The third connection example of the second embodiment has substantially the same configuration as that of the fourth connection example of the first embodiment illustrated in FIG. 17. Therefore, the third connection example of the second embodiment is described in terms of differences from the fourth connection example of the first embodiment illustrated in FIG. 17.

In the third connection example of the second embodiment, the additional random number circuits 88 are arranged in each of the layers in correspondence with the neuron circuits 22.

In this case, each of the synapse circuits 20 supplies the output signal to the neuron circuits 22 arranged in the same layer. Each of the two or more synapse circuits 20 arranged in the same layer acquires the firing signal output from the same neuron circuit 22 as an input signal.

In this neural network device 10 in the third connection example of the second embodiment, the random number circuits 24 can be arranged in a layer differing from the layers where the synapse circuits 20 are arranged. Each of the random number circuits 24 supplies the random signal to the corresponding two or more synapse circuits 20 through the layers.

This neural network device 10 in the third connection example of the second embodiment enables efficient arrangement of the synapse circuits 20, the neuron circuits 22, the random number circuits 24, and the additional random number circuits 88. Moreover, the neural network device 10 in the third connection example of the second embodiment enables efficient connection of wiring transmitting the input signals.

In the third connection example of the second embodiment, each of the synapse groups 80 includes two or more synapse circuits 20 arranged in mutually different layers. Moreover, each of the synapse groups 80 includes two or more synapse circuits 20 that are included in the same layer and that perform output of output signals to mutually different neuron circuits 22. Therefore, the neural network device 10 in the third connection example of the second embodiment enables further reduction in the number of the random number circuits 24.

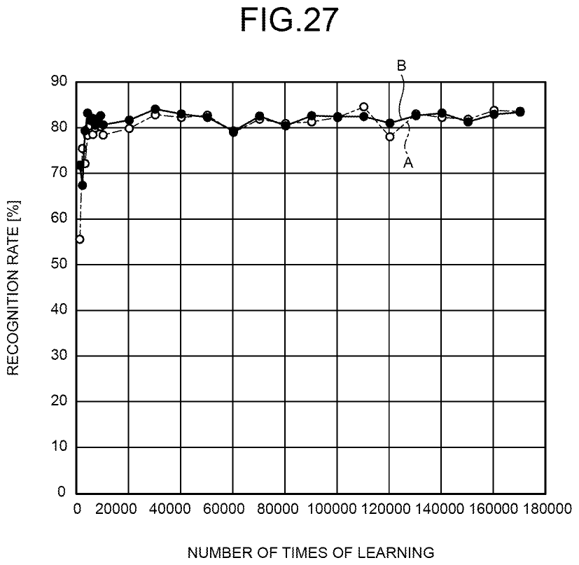

FIG. 27 is a diagram illustrating a result of recognition rate simulation of the neural network device 10 of the second embodiment. Note that line A in FIG. 27 indicates recognition rates when the spiking neural network illustrated in FIG. 11 is configured according to the third connection example of the second embodiment. Line B in FIG. 27 indicates recognition rates when the spiking neural network illustrated in FIG. 11 has such a configuration that all the synapses receive the random signals from mutually independent probability generators.

When the spiking neural network configured according to the third connection example of the second embodiment learns the MNIST handwritten character for pattern recognition, the recognition rates relative to the numbers of times of learning are approximately 80% as illustrated by A in FIG. 27. The recognition rates A in FIG. 27 are almost equal to the recognition rates illustrated by B in FIG. 27 when all the synapses receive the random signals from mutually independent probability generators. Therefore, the spiking neural network in FIG. 11 configured according to the third connection example of the second embodiment can learn accurately.

The synapse circuit 20 of the first embodiment stochastically updates the synaptic weight on the basis of the random signal acquired from the random number circuit 24. In contrast, the synapse circuit 20 of the second embodiment stochastically updates the synaptic weight on the basis of two signals, the random signal acquired from the random number circuit 24 and the additional random signal acquired from the additional random number circuit 88. This enables each of the synapse circuits 20 of the second embodiment to stochastically update the synaptic weight highly independently, which improves learning accuracy.

In comparison to the first embodiment, the neural network device 10 of the second embodiment may become large-scale circuitry due to addition of the additional random number circuits 88. However, in the spiking neural network illustrated in FIG. 11, the number of the probability generators when independent probability generators are provided for all the synapses of the synapse circuits 20 is n×m. Note that n is the number of the neurons included in the input layer. m is the number of the neurons included in the processing layer. In contrast, in the spiking neural network illustrated in FIG. 11 when applied with the neural network device 10 of the second embodiment, the number of the random number circuits 24 and the additional random number circuits 88 is n+m. In other words, whereas the probability generators required conventionally are as many as the power of 2 relative to the network scale, the random number generators required in the neural network device 10 of the second embodiment are as many as the power of 1 relative to the network scale. Therefore, the neural network device 10 of the second embodiment provides larger reduction in circuitry scale in a large-scale network.

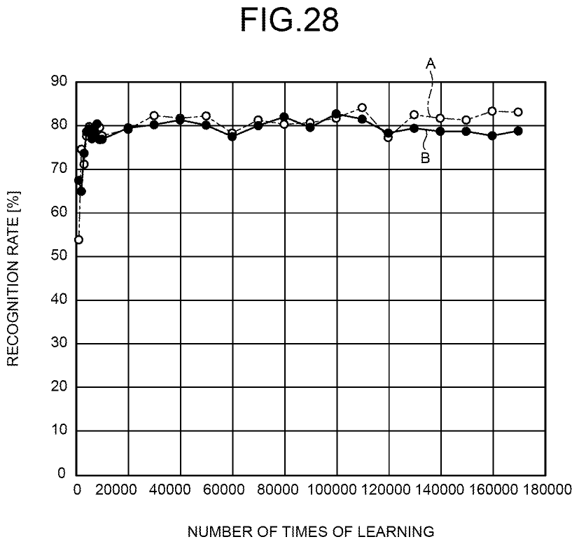

FIG. 28 is a diagram illustrating a result of recognition rate simulation of the neural network device 10 of the second embodiment when the first probability and the second probability are varied.

A line A in FIG. 28 indicates recognition rates when the spiking neural network illustrated in FIG. 11 is configured according to the third connection example of the second embodiment with the first probability larger than the second probability. A line B in FIG. 28 indicates recognition rates when the spiking neural network illustrated in FIG. 11 is configured according to the third connection example of the second embodiment with the second probability larger than the first probability.

Each of the synapse circuits 20 stochastically updates the assigned synaptic weight in accordance with the predetermined synapse update rule with the probability obtained by multiplying the predetermined first probability generated on the basis of the received random signal by the predetermined second probability generated on the basis of the additional random signal.

In present embodiment, the first probability is set larger than the second probability. In other words, each of the synapse circuits 20 controls the probability using the random signal output from the random number circuit 24 more dominantly than the additional random signal output from the additional random number circuit 88. The additional random number circuits 88 are provided in correspondence with the neuron circuits 22. Therefore, when the probability is controlled by using the additional random signal dominantly, each of the synapse circuits 20 is less independent, and the learning accuracy may be lowered. As illustrated in FIG. 28, the recognition rates are higher and more stable relative to the numbers of times of learning when the first probability is larger than the second probability (A in FIG. 28) than when the second probability is larger than the first probability (B in FIG. 28).

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplement

The above-described embodiments can be summarized in the following technical schemes.

### (Technical Scheme 1)

A neural network device comprising:
a plurality of neuron circuits;
a plurality of synapse circuits; and
a plurality of random number circuits, wherein
each of the neuron circuits is configured to receive an output signal output from each of one or more of the synapse circuits and output a firing signal in accordance with the received output signal,
each of the random number circuits is configured to output a random signal representing a random number periodically changed,
each of the synapse circuits includes:
   a storage circuit configured to store a synaptic weight;
   a transmission circuit configured to
      receive an input signal being the firing signal output from a pre-neuron circuit being one of the neuron circuits, and
      output an output signal to a post-neuron circuit being one of the neuron circuits, the output signal being obtained by adding influence of the synaptic weight to the received input signal;
   a probability control circuit configured to
      receive the random signal from one of the random number circuits,
      permit update of the synaptic weight with a probability generated based on the received random signal, and
      prohibit update of the synaptic weight unless the synaptic weight is permitted to be updated; and
   an update circuit configured, when the input signal is received from the pre-neuron circuit, to update the synaptic weight in accordance with a feedback signal on condition that the synaptic weight is permitted to be updated, the feedback signal representing operation of the post-neuron circuit or a state of the post-neuron circuit,
the synapse circuits are divided into synapse groups,
two or more synapse circuits are each configured to receive the random signal output from a first random number circuit out of the random number circuits, the two or more synapse circuits belonging to a first synapse group out of the synapse groups, and
two or more synapse circuits, each outputting the output signal to a first neuron circuit out of the neuron circuits, belong to a synapse group differing from a synapse group to which other synapse circuits, each outputting the output signal to the first neuron circuit, belong.

### (Technical Scheme 2)

The neural network device according to the technical scheme 1, wherein
the random signal represents a random number in a numerical range from a predetermined lower limit value to a predetermined upper limit value, and
the probability control circuit is configured to
   permit update of the synaptic weight when a value of the random signal falls within a range corresponding to a predetermined first probability, and
   prohibit update of the synaptic weight when the value of the random signal falls outside the range corresponding to the first probability.

### (Technical Scheme 3)

The neural network device according to the technical scheme 1 or 2, wherein each of the two or more synapse circuits belonging to the first synapse group is configured to receive the input signal output from a second neuron circuit out of the neuron circuits.

### (Technical Scheme 4)

The neural network device according to any one of the technical schemes 1 to 3, further comprising a plurality of additional random number circuits, wherein
each of the additional random number circuits is configured to output an additional random signal representing a random number periodically changed, and
the probability control circuit is configured to:
   receive the additional random signal from one of the additional random number circuits; and
   permit update of the synaptic weight with a probability obtained by multiplying a first probability by a predetermined second probability, the first probability being generated based on the random signal, the second probability being generated based on the additional random signal.

### (Technical Scheme 5)

The neural network device according to the technical scheme 4, wherein
the additional random signal represents a random number in a numerical range from a predetermined lower limit value to a predetermined upper limit value, and
the probability control circuit is configured to:
   permit update of the synaptic weight when a value of the random signal falls within a range corresponding to the first probability and a value of the additional random signal falls within a range corresponding to the second probability; and
   prohibit update of the synaptic weight when the value of the random signal falls outside the range corresponding to the first probability, or when the value of the additional random signal falls outside the range corresponding to the second probability.

### (Technical Scheme 6)

The neural network device according to the technical scheme 4 or 5, wherein
the additional random number circuits are provided to have a one-to-one correspondence with the neuron circuits, and
each of the synapse circuits is configured to receive the additional random signal from one of the additional random number circuits corresponding to a neuron circuit to which the output signal is output.

### (Technical Scheme 7)

The neural network device according to any one of the technical schemes 4 to 6, wherein the first probability is larger than the second probability.

### (Technical Scheme 8)

The neural network device according to any one of the technical schemes 1 to 3, wherein
the feedback signal is represented by a first value or a second value,
the update circuit is configured to:
   when the input signal is received in a state where the feedback signal has the first value, change the synaptic weight in an increment direction on condition that the synaptic weight is permitted to be updated; and,
   when the input signal is received in a state where the feedback signal has the second value, change the synaptic weight in a decrement direction on condition that the synaptic weight is permitted to be updated, and
the probability control circuit is configured to:
   when the synaptic weight is changed in the increment direction, permit update of the synaptic weight with a predetermined first increase probability generated based on the random signal; and,
   when the synaptic weight is changed in the decrement direction, permit update of the synaptic weight with a predetermined first decrease probability generated based on the random signal.

### (Technical Scheme 9)

The neural network device according to any one of the technical schemes 4 to 7, wherein
the feedback signal is represented by a first value or a second value,
the update circuit is configured to:
   when the input signal is received in a state where the feedback signal has the first value, change the synaptic weight in an increment direction on condition that the synaptic weight is permitted to be updated; and,
   when the input signal is received in a state where the feedback signal has the second value, change the synaptic weight in a decrement direction on condition that the synaptic weight is permitted to be updated, and
the probability control circuit is configured to:
   when the synaptic weight is changed in the increment direction, permit update of the synaptic weight with a probability obtained by multiplying a predetermined first increase probability by a predetermined second increase probability, the first increase probability being generated based on the random signal, the second increase probability being generated based on the additional random signal; and
   when the synaptic weight is changed in the decrement direction, permit update of the synaptic weight with a probability obtained by multiplying a predetermined first decrease probability by a predetermined second decrease probability, the first decrease probability being generated based on the random signal, the second decrease probability being generated based on the additional random signal.

### (Technical Scheme 10)

The neural network device according to the technical schemes 8 or 9, wherein
the synaptic weight is changed in a predetermined numerical range, and
the storage circuit is configured not to change the synaptic weight to become equal to or larger than an upper limit value of the numerical range, and not to change the synaptic weight to become equal to or smaller than a lower limit value of the numerical range.

### (Technical Scheme 11)

The neural network device according to any one of the technical schemes 8 to 10, wherein the feedback signal has the first value for a given period of time after firing of the post-neuron circuit and has the second value for a period of time other than the given period.

### (Technical Scheme 12)

The neural network device according to any one of the technical schemes 8 to 10, wherein
each of the neuron circuits is configured to
   hold an inner potential varied with a level or duration of the received output signal, and
   output the firing signal when the inner potential is larger than a preset firing threshold, and
the feedback signal has the first value when the inner potential held by the post-neuron circuit is equal to or larger than a predetermined value and has the second value when the inner potential is smaller than the predetermined value.

### (Technical Scheme 13)

The neural network device according to any one of the technical schemes 1 to 12, wherein the synaptic weight is represented by a discrete value.

### (Technical Scheme 14)

The neural network device according to the technical scheme 13, wherein the synaptic weight is represented in binary.

### (Technical Scheme 15)

The neural network device according to any one of the technical schemes 1 to 14, wherein at least one of the synapse circuits is configured to supply the output signal to the pre-neuron circuit in the neuron circuits or to a neuron circuit disposed in a stage previous to a synapse circuit from which the output signal is supplied to the pre-neuron circuit.

### (Technical Scheme 16)

A synaptic weight update method implemented by a computer as a neural network device, the neural network device including:
a plurality of neuron circuits;
a plurality of synapse circuits; and
a plurality of random number circuits, wherein
each of the neuron circuits is configured to receive an output signal output from each of one or more of the synapse circuits and output a firing signal in accordance with the received output signal,
each of the random number circuits is configured to output a random signal representing a random number periodically changed,
each of the synapse circuits includes:
   a storage circuit configured to store a synaptic weight; and
   a transmission circuit configured to
      receive an input signal being the firing signal output from a pre-neuron circuit being one of the neuron circuits, and
      output an output signal to a post-neuron circuit being one of the neuron circuits, the output signal being obtained by adding influence of the synaptic weight to the received input signal,
the synapse circuits are divided into synapse groups,
two or more synapse circuits are each configured to receive the random signal output from a first random number circuit out of the random number circuits, the two or more synapse circuits belonging to a first synapse group out of the synapse groups, and
two or more synapse circuits, each outputting the output signal to a first neuron circuit out of the neuron circuits, belong to a synapse group differing from a synapse group to which other synapse circuits, each outputting the output signal to the first neuron circuit, belong, and
each of the synapse circuits executes processing including:
   receiving the random signal from one of the random number circuits;
   permitting update of the synaptic weight with a probability generated based on the received random signal;
   prohibiting update of the synaptic weight unless the synaptic weight is permitted to be updated; and,
   when the input signal is received from the pre-neuron circuit, updating the synaptic weight in accordance with a feedback signal on condition that the synaptic weight is permitted to be updated, the feedback signal representing operation of the post-neuron circuit or a state of the post-neuron circuit.

What is claimed is:

1. A neural network device comprising:
a plurality of neuron circuits;
a plurality of synapse circuits; and
a plurality of random number circuits, wherein
each of the neuron circuits is configured to receive an output signal output from each of one or more of the synapse circuits and output a firing signal in accordance with the received output signal,
each of the random number circuits is configured to output a random signal representing a random number periodically changed,
each of the synapse circuits includes:
a storage circuit configured to store a synaptic weight;
a transmission circuit configured to
receive an input signal being the firing signal output from a pre-neuron circuit being one of the neuron circuits, and
output an output signal to a post-neuron circuit being one of the neuron circuits, the output signal being obtained by adding influence of the synaptic weight to the received input signal;
a probability control circuit configured to
receive the random signal from one of the random number circuits,
permit update of the synaptic weight with a probability generated based on the received random signal, and
prohibit update of the synaptic weight unless the synaptic weight is permitted to be updated; and
an update circuit configured, when the input signal is received from the pre-neuron circuit, to update the synaptic weight in accordance with a feedback signal on condition that the synaptic weight is permitted to be updated, the feedback signal representing operation of the post-neuron circuit or a state of the post-neuron circuit,
the synapse circuits are divided into synapse groups,
two or more synapse circuits are each configured to receive the random signal output from a first random number circuit out of the random number circuits, the two or more synapse circuits belonging to a first synapse group out of the synapse groups, and
two or more synapse circuits, each outputting the output signal to a first neuron circuit out of the neuron circuits, belong to a synapse group differing from a synapse group to which other synapse circuits, each outputting the output signal to the first neuron circuit, belong.

2. The neural network device according to claim 1, wherein
the random signal represents a random number in a numerical range from a predetermined lower limit value to a predetermined upper limit value, and
the probability control circuit is configured to
permit update of the synaptic weight when a value of the random signal falls within a range corresponding to a predetermined first probability, and
prohibit update of the synaptic weight when the value of the random signal falls outside the range corresponding to the first probability.

3. The neural network device according to claim 1, wherein each of the two or more synapse circuits belonging to the first synapse group is configured to receive the input signal output from a second neuron circuit out of the neuron circuits.

4. The neural network device according to claim 1, further comprising a plurality of additional random number circuits, wherein
each of the additional random number circuits is configured to output an additional random signal representing a random number periodically changed, and
the probability control circuit is configured to:
receive the additional random signal from one of the additional random number circuits; and
permit update of the synaptic weight with a probability obtained by multiplying a first probability by a predetermined second probability, the first probability being generated based on the random signal, the second probability being generated based on the additional random signal.

5. The neural network device according to claim 4, wherein
the additional random signal represents a random number in a numerical range from a predetermined lower limit value to a predetermined upper limit value, and
the probability control circuit is configured to:
permit update of the synaptic weight when a value of the random signal falls within a range corresponding to the first probability and a value of the additional random signal falls within a range corresponding to the second probability; and
prohibit update of the synaptic weight when the value of the random signal falls outside the range corresponding to the first probability, or when the value of the additional random signal falls outside the range corresponding to the second probability.

6. The neural network device according to claim 4, wherein
the additional random number circuits are provided to have a one-to-one correspondence with the neuron circuits, and
each of the synapse circuits is configured to receive the additional random signal from one of the additional random number circuits corresponding to a neuron circuit to which the output signal is output.

7. The neural network device according to claim 4, wherein the first probability is larger than the second probability.

8. The neural network device according to claim 1, wherein
the feedback signal is represented by a first value or a second value,
the update circuit is configured to:
when the input signal is received in a state where the feedback signal has the first value, change the synaptic weight in an increment direction on condition that the synaptic weight is permitted to be updated; and,
when the input signal is received in a state where the feedback signal has the second value, change the synaptic weight in a decrement direction on condition that the synaptic weight is permitted to be updated, and
the probability control circuit is configured to:
when the synaptic weight is changed in the increment direction, permit update of the synaptic weight with a predetermined first increase probability generated based on the random signal; and,
when the synaptic weight is changed in the decrement direction, permit update of the synaptic weight with a predetermined first decrease probability generated based on the random signal.

9. The neural network device according to claim 4, wherein
the feedback signal is represented by a first value or a second value,
the update circuit is configured to:
when the input signal is received in a state where the feedback signal has the first value, change the synaptic weight in an increment direction on condition that the synaptic weight is permitted to be updated; and,
when the input signal is received in a state where the feedback signal has the second value, change the synaptic weight in a decrement direction on condition that the synaptic weight is permitted to be updated, and
the probability control circuit is configured to:
when the synaptic weight is changed in the increment direction, permit update of the synaptic weight with a probability obtained by multiplying a predetermined first increase probability by a predetermined second increase probability, the first increase probability being generated based on the random signal, the second increase probability being generated based on the additional random signal; and
when the synaptic weight is changed in the decrement direction, permit update of the synaptic weight with a probability obtained by multiplying a predetermined first decrease probability by a predetermined second decrease probability, the first decrease probability being generated based on the random signal, the second decrease probability being generated based on the additional random signal.

10. The neural network device according to claim 8, wherein
the synaptic weight is changed in a predetermined numerical range, and
the storage circuit is configured not to change the synaptic weight to become equal to or larger than an upper limit value of the numerical range, and not to change the synaptic weight to become equal to or smaller than a lower limit value of the numerical range.

11. The neural network device according to claim 8, wherein the feedback signal has the first value for a given period of time after firing of the post-neuron circuit and has the second value for a period of time other than the given period.

12. The neural network device according to claim 8, wherein
each of the neuron circuits is configured to
hold an inner potential varied with a level or duration of the received output signal, and
output the firing signal when the inner potential is larger than a preset firing threshold, and
the feedback signal has the first value when the inner potential held by the post-neuron circuit is equal to or larger than a predetermined value and has the second value when the inner potential is smaller than the predetermined value.

13. The neural network device according to claim 1, wherein the synaptic weight is represented by a discrete value.

14. The neural network device according to claim 13, wherein the synaptic weight is represented in binary.

15. The neural network device according to claim 1, wherein at least one of the synapse circuits is configured to supply the output signal to the pre-neuron circuit in the neuron circuits or to a neuron circuit disposed in a stage previous to a synapse circuit from which the output signal is supplied to the pre-neuron circuit.

16. A synaptic weight update method implemented by a computer as a neural network device, the neural network device including:
a plurality of neuron circuits;
a plurality of synapse circuits; and
a plurality of random number circuits, wherein
each of the neuron circuits is configured to receive an output signal output from each of one or more of the synapse circuits and output a firing signal in accordance with the received output signal,
each of the random number circuits is configured to output a random signal representing a random number periodically changed,
each of the synapse circuits includes:
a storage circuit configured to store a synaptic weight; and
a transmission circuit configured to
receive an input signal being the firing signal output from a pre-neuron circuit being one of the neuron circuits, and
output an output signal to a post-neuron circuit being one of the neuron circuits, the output signal being obtained by adding influence of the synaptic weight to the received input signal,
the synapse circuits are divided into synapse groups,
two or more synapse circuits are each configured to receive the random signal output from a first random number circuit out of the random number circuits, the two or more synapse circuits belonging to a first synapse group out of the synapse groups, and
two or more synapse circuits, each outputting the output signal to a first neuron circuit out of the neuron circuits, belong to a synapse group differing from a synapse group to which other synapse circuits, each outputting the output signal to the first neuron circuit, belong, and
each of the synapse circuits executes processing including:
receiving the random signal from one of the random number circuits;
permitting update of the synaptic weight with a probability generated based on the received random signal;
prohibiting update of the synaptic weight unless the synaptic weight is permitted to be updated; and,
when the input signal is received from the pre-neuron circuit, updating the synaptic weight in accordance with a feedback signal on condition that the synaptic weight is permitted to be updated, the feedback signal representing operation of the post-neuron circuit or a state of the post-neuron circuit.
